(19) United States
(12) Patent Application Publication
(10) Pub. No.: US 2026/0087722 A1
(43) Pub. Date: Mar. 26, 2026

(54) PERSPECTIVE MAPPING OF CONTENT ONTO REAL-WORLD STRUCTURES

(71) Applicant: Sphere Entertainment Group, LLC, New York, NY (US)

(72) Inventors: Tanner Luke THOMPSON, Fort Wayne, IN (US); Brook John STEARN, Rancho Palos Verdes, CA (US); Robert Ashely WAGERS, Los Angeles, CA (US); Liam McClellan WARD, Burbank, CA (US)

(73) Assignee: Sphere Entertainment Group, LLC, New York, NY (US)

(21) Appl. No.: 19/333,802

(22) Filed: Sep. 19, 2025

Related U.S. Application Data
(60) Provisional application No. 63/699,487, filed on Sep. 26, 2024.

(51) Int. Cl. G06T 15/04

(52) U.S. Cl. CPC G06T 15/04

(57) ABSTRACT

Systems, methods, and apparatuses disclosed herein can map content items onto a venue using rendering-based, replication-based, and region-based mappings. In rendering-based mapping, multiple renderings of the content items are captured from multiple locations. In replication-based mapping, a single rendering is captured from one location and replicated across the venue. In region-based mapping, the venue is divided into distinct three-dimensional physical surfaces, and content items is mapped onto each region, optionally using virtual representations, transformations, and virtual texture maps to ensure geometric, photometric, and spatial coherence across the surfaces.

### CROSS-REFERENCE TO RELATED APPLICATIONS

The present application claims the benefit of U.S. Provisional Patent Application No. 63/699,487, filed Sep. 26, 2024, which is incorporated herein by reference in its entirety.

### BACKGROUND

Immersive display technologies are increasingly deployed in entertainment, education, simulation, and collaborative environments. Conventional systems often rely on flat screens or head-mounted displays, which can restrict the field of view and limit the sense of spatial presence. Projection-based systems have attempted to extend immersion by displaying content items across large walls, domes, or irregular structures. However, accurately adapting visual content items to complex three-dimensional geometries presents significant challenges. Misalignment, perspective distortion, and scaling inconsistencies can degrade the experience, particularly when viewed from multiple positions within a venue. Moreover, existing systems frequently lack the ability to dynamically adapt content items to the physical characteristics of the environment, such as curvature, surface texture, or lighting conditions. As a result, viewers may encounter breaks in continuity or reduced realism, limiting the effectiveness of these immersive experiences.

### BRIEF DESCRIPTION OF THE DRAWINGS

The present disclosure is described with reference to the accompanying drawings. In the drawings, like reference numbers indicate identical or functionally similar elements. Additionally, the left most digit(s) of a reference number identifies the drawing in which the reference number first appears. In the accompanying drawings:

FIG. 1 illustrates a simplified block diagram of an exemplary real-world environment having an exemplary real-world structure according to some exemplary embodiments of the present disclosure;

FIG. 2A through FIG. 2D graphically illustrate exemplary rendering-based mapping of exemplary real-world content items onto the exemplary real-world structure according to some exemplary embodiments of the present disclosure;

FIG. 3 illustrates an exemplary operational control flow for the exemplary rendering-based mapping of exemplary real-world content items onto the exemplary real-world venue according to some exemplary embodiments of the present disclosure;

FIG. 4A through FIG. 4E graphically illustrate an exemplary replication-based mapping of exemplary real-world content items onto the exemplary real-world structure according to some exemplary embodiments of the present disclosure;

FIG. 5 illustrates an exemplary operational control flow for the exemplary replication-based mapping of exemplary real-world content items onto the exemplary real-world venue according to some exemplary embodiments of the present disclosure;

FIG. 6A through FIG. 6D graphically illustrate exemplary region-based mapping of exemplary real-world content items onto the exemplary real-world structure according to some exemplary embodiments of the present disclosure;

FIG. 7 illustrates an exemplary operational control flow for region-based mapping of exemplary real-world content items onto an exemplary real-world venue according to some exemplary embodiments of the present disclosure; and

FIG. 8 graphically illustrates a simplified block diagram of a computing device that can incorporated within the exemplary real-world environment according to some embodiments of the present disclosure.

The present disclosure will now be described with reference to the accompanying drawings.

### DETAILED DESCRIPTION

The following disclosure provides many different embodiments, or examples, for implementing different features of the provided subject matter. Specific examples of components and arrangements are described herein to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not in itself dictate a relationship between the various embodiments and/or configurations discussed. It is noted that, in accordance with the standard practice in the industry, features are not drawn to scale. In fact, the dimensions of the features may be arbitrarily increased or reduced for clarity of discussion. The following disclosure may include the terms “about” or “substantially” to indicate the value of a given quantity can vary based on a particular technology. Based on the technology, the term “about” or “substantially” can indicate a value of a given quantity that varies within, for example, 1-15% of the value (e.g., +1%, +2%, +5%, +10%, or +15% of the value).

### Overview

There is a need for improved systems and methods capable of mapping content items onto real-world venues in ways that adapt to the geometry, curvature, and lighting of three-dimensional surfaces, providing immersive experiences across multiple viewing positions. Systems, methods, and apparatuses disclosed herein can map these content items onto a venue using rendering-based, replication-based, and region-based mappings. In rendering-based mapping, multiple renderings of the content items are captured from multiple locations. In replication-based mapping, a single rendering is captured from one location and replicated across the venue. In region-based mapping, the venue is divided into distinct three-dimensional physical surfaces, and content items is mapped onto each region, optionally using virtual representations, transformations, and virtual texture maps to ensure geometric, photometric, and spatial coherence across the surfaces.

### Exemplary Real-World Environment Having an Exemplary Real-World Structure

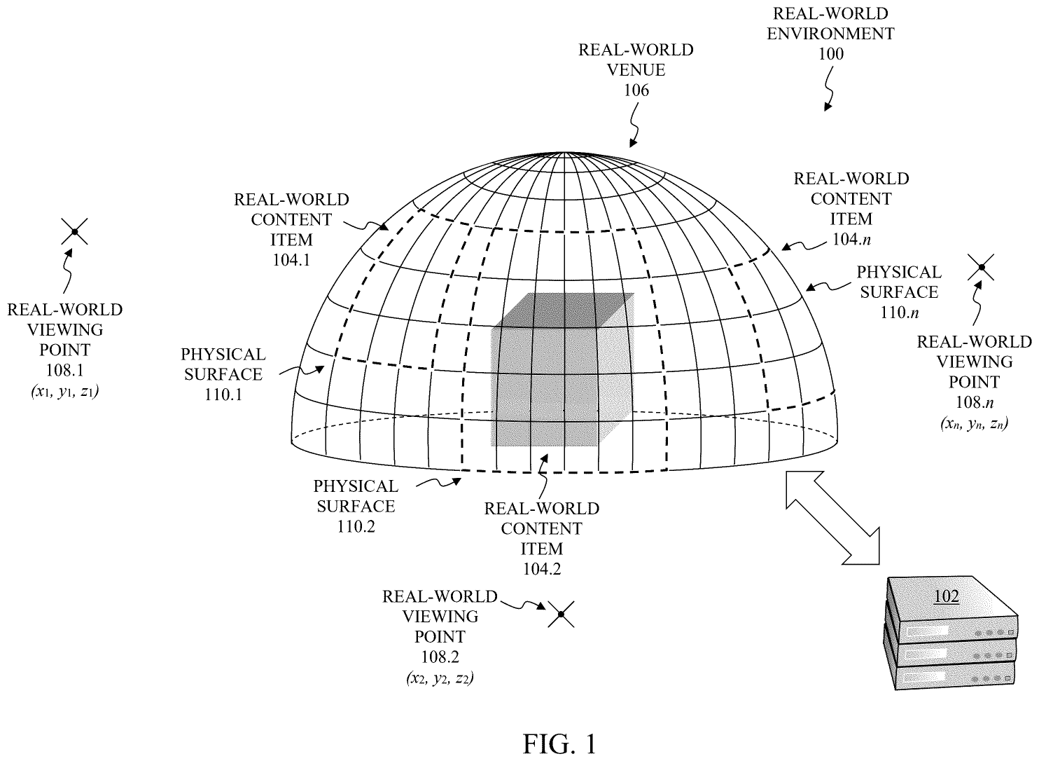

FIG. 1 illustrates a simplified block diagram of an exemplary real-world environment having an exemplary real-world structure according to some exemplary embodiments of the present disclosure. In the exemplary embodiment illustrated in FIG. 1, a real-world environment 100 includes a content mapping server 102 to map real-world content items 104.1 through 104.n onto a real-world venue 106. In some embodiments, the content mapping server 102 maps the real-world content items 104.1 through 104.n onto three-dimensional physical surfaces 110.1 through 110.n of the real-world venue 106 to create an immersive visual experience that can be beneficially viewed from multiple locations within the real-world environment 100. In these embodiments, the content mapping server 102 can incorporate a rendering-based mapping, a replication-based mapping, and/or a region-based mapping to map the real-world content items 104.1 through 104.n onto the real-world venue 106. In the rendering-based mapping, the content mapping server 102 can strategically capture the real-world content items 104.1 through 104.n from multiple locations within the real-world environment 100 and map the real-world content items 104.1 through 104.n onto the real-world venue 106 to create a perspective-consistent immersive experience. In the replication-based mapping, the content mapping server 102 can strategically capture a single rendering of the real-world content items 104.1 through 104.n from one location within the real-world environment 100 and map replications of this single rendering across the real-world venue 106 to provide a consistent immersive experience from multiple locations within the real-world environment 100. In the region-based mapping approach, the content mapping server 102 can strategically divide the real-world venue 106 into the three-dimensional physical surfaces 110.1 through 110.n and map the real-world content items 104.1 through 104.n onto the three-dimensional physical surfaces 110.1 through 110.n to create a consistent, immersive, and perspective-correct visual experience across the real-world venue 106. By employing any combination of these mappings, the content mapping server 102 can ensure a meaningful and engaging experience for viewers while enhancing the aesthetic and communicative value of the real-world content items 104.1 through 104.n.

In some embodiments, the rendering-based mapping may be preferred when the real-world content items 104.1 through 104.n is complex, volumetric, and/or interactive, or when the real-world viewers are distributed across multiple locations with distinct viewing angles within the real-world environment 100. In this approach, the real-world viewers receive specially tailored renderings of the real-world content items 104.1 through 104.n, which can enhance depth perception, immersion, and interaction fidelity. The rendering-based mapping can be particularly advantageous when the real-world venue 106 is irregular, curved, or hemispherical, where minimizing visual distortion improves the aesthetic and communicative value of the real-world content items 104.1 through 104.n. Alternatively, the replication-based mapping may be preferred when the real-world content items 104.1 through 104.n is simple, static, or primarily front-facing, and when it is desirable for the real-world viewers at multiple locations within the real-world environment 100 to each perceive a substantially complete version of the real-world content items 104.1 through 104.n. This replication-based mapping can provide a computationally simpler solution while still ensuring that the real-world viewers see complete versions of the real-world content items 104.1 through 104.n. Alternatively, the region-based mapping may be preferred when the real-world venue 106 includes convex, spherical, or multi-region surfaces, or when it is desirable to present the real-world content items 104.1 through 104.n across the three-dimensional physical surfaces 110.1 through 110.n of the real-world venue 106. This region-based mapping can be particularly advantageous when the real-world content items 104.1 through 104.n includes dynamic, animated, and/or perspective-dependent imagery, among others, or when creating region-specific visual experiences enhances depth perception, immersion, and/or engagement, among others. This region-based mapping can also be preferred when a simpler computational solution is desired for delivering multi-region, perspective-correct content items, while still providing visually engaging experiences for viewers across multiple locations within the real-world environment 100. In some embodiments, the rendering-based mapping, the replication-based mapping, and/or the region-based mapping can be selected based on the nature of the real-world content items 104.1 through 104.n, the geometry of the real-world venue 106, and the desired viewer experience.

In the exemplary embodiment illustrated in FIG. 1, the real-world content items 104.1 through 104.n can represent, or be derived from, one or more textual content items, images, videos, graphics, animations, interactive content items, dynamic content items, augmented reality (AR) content items, product demonstrations and simulations, event information and schedules, social media content items, branding and identities, background visuals and ambient content items, interactive wayfinding and directories, and/or educational and informational content items, among others, referred to as source content items for simplicity. In some embodiments, these source content items can be obtained from one or more sources, for example, one or more captured images or video sequences, photogrammetry or Light Detection and Ranging (LiDAR) scans, computer-generated imagery (CGI) including virtual camera renders, volumetric video, motion graphics, and/or other digital or physical data sources, among others. In some embodiments, the real-world content items 104.1 through 104.n can be classified as being volumetric content items that are characterized as having, for example, depth and/or volume, anamorphic visual content items that are characterized as being perceived to have, for example, depth and/or volume, pass-through visual content items, and/or augmented reality visual content items, among others. Although the real-world content items 104.1 through 104.n is illustrated as being a simple three-dimensional cube in FIG. 1, those skilled in the relevant art(s) will recognize that this is for exemplary purposes only and not limiting. Rather, those skilled in the relevant art(s) will recognize the real-world content items 104.1 through 104.n can range from simple three-dimensional content items, such as a cube, a prism, a pyramid, a sphere, a cone, or a cylinder, among others, to more complicated three-dimensional content items, such as volumetric video, three-dimensional holograms, point clouds, voxel models, and/or augmented reality experiences, among others, without departing from the spirit and scope of the present disclosure.

In the exemplary embodiment illustrated in FIG. 1, the content mapping server 102 can map the real-world content items 104.1 through 104.n onto the three-dimensional physical surfaces 110.1 through 110.n of the real-world venue 106. Generally, the real-world venue 106 can represent a three-dimensional physical structure within the real-world environment 100 that is capable of displaying the real-world content items 104.1 through 104.n. In some embodiments, the three-dimensional physical structure can represent any suitable building and/or non-building structure that will be apparent to those skilled in the relevant art(s) that can display the real-world content items 104.1 through 104.n. In these embodiments, the building structure refers to any suitable structure or structures that are designed for human occupancy and can include residential, industrial, and/or commercial building structures to provide some examples. In these embodiments, the real-world venue 106 can represent a music real-world venue, for example, a music theater, a music club, and/or a concert hall, a sporting real-world venue, for example, an arena, a convention center, and/or a stadium, and/or any other suitable real-world venue that will be apparent to those skilled in the relevant art(s) without departing the spirit and scope of the present disclosure. In these embodiments, the real-world venue 106 can host an event, such as a musical event, a theatrical event, a sporting event, a motion picture, and/or any other suitable event that will be apparent to those skilled in the relevant art(s) without departing the spirit and scope of the present disclosure. For example, the real-world venue 106 can be implemented as a hemisphere structure, also referred to as a hemispherical dome, that hosts the event. In some embodiments, the non-building structure refers to any suitable structure or structures that are not designed for human occupancy and can include residential, industrial, and/or commercial non-building structures to provide some examples. In some embodiments, the real-world venue 106 can include visual displays that are spread across the real-world venue 106. In these embodiments, the visual displays can include approximately 55,700 square meters of programmable light-emitting diode (LED) light panels that create the appearance of a giant screen that are spread across the exterior, or the outer shell, of the real-world venue 106. In these embodiments, the visual displays can include rows and columns of programmable picture elements, also referred to as pixels, in three-dimensional space that form programmable picture element light panels to display the real-world content items 104.1 through 104.n as described herein. In these embodiments, the pixels can be implemented using light-emitting diode (LED) displays, organic light-emitting diode (OLED) displays, and/or quantum dots (QDs) displays, among others, to provide some examples.

As part of mapping the real-world content items 104.1 through 104.n onto the real-world venue 106, the content mapping server 102 can identify real-world viewing points 108.1 through 108.n within the real-world environment 100 for observing the real-world venue 106. In some embodiments, the real-world viewing points 108.1 through 108.n correspond to distinct locations within the real-world environment 100 where real-world viewers are expected to be situated within the real-world environment 100 to view the real-world venue 106. In these embodiments, the content mapping server 102 can treat the real-world viewing points 108.1 through 108.n as virtualized observation nodes, characterized by parameters such as fields of view, near and far clipping planes, depth ranges, and/or eye separation distances in stereoscopic configurations, among others. By parameterizing the real-world viewing points 108.1 through 108.n in this manner, the content mapping server 102 can accurately simulate how the real-world viewers would perceive the real-world venue 106 at the real-world viewing points 108.1 through 108.n. In some embodiments, the real-world viewing points 108.1 through 108.n can be expressed as three-dimensional locations within the real-world environment 100 for observing the real-world content items 104.1 through 104.n that has been mapped onto the real-world venue 106. For example, the real-world viewing points 108.1 through 108.n can include ground-level views, bird's-eye view, worm's-eye view, aerial views, panoramic views, and/or isometric views, among others, of the real-world content items 104.1 through 104.n. As illustrated in FIG. 1, the real-world viewing points 108.1 through 108.n can include a first real-world viewing point 108.1 having three-dimensional coordinates (x₁, y₁, z₁) in a Cartesian coordinate system, a second real-world viewing point 108.2 having three-dimensional coordinates (x₂, y₂, z₂) in the Cartesian coordinate system, and/or an n^{th} real-world viewing point 108.1 having three-dimensional coordinates (xₙ, yₙ, zₙ) in the Cartesian coordinate system. Although the real-world viewing points 108.1 through 108.n are illustrated in FIG. 1 as including these real-world viewing points, this is for exemplary purposes only and not limiting. Those skilled in the relevant art(s) will recognize the real-world viewing points 108.1 through 108.n can range from a single viewing point to tens, hundreds, and even more viewing points without departing from the spirit and scope of the present disclosure. And although the real-world viewing points 108.1 through 108.n are illustrated in the Cartesian coordinate system in FIG. 1, those skilled in the relevant art(s) will recognize that the real-world viewing points 108.1 through 108.n can be similarly represented in other coordinate systems, such as spherical and/or cylindrical, among others, to provide some examples, without departing from the spirit and scope of the present disclosure.

In some embodiments, the content mapping server 102 can access the source content items for mapping onto the real-world venue 106. In these embodiments, the content mapping server 102 can strategically capture these source content items from multiple locations within the real-world environment 100 in the rendering-based mapping, strategically capture a single rendering of these source content items from one location within the real-world environment 100 and replicate this single rendering across the real-world venue 106 in the replication-based mapping, and/or assign these source content items to the three-dimensional physical surfaces 110.1 through 110.n of the real-world venue 106 in the region-based mapping to provide the real-world content items 104.1 through 104.n. Generally, the source content items can be generated in a variety of ways, such as through manual or artistic techniques, virtual camera-based rendering pipelines, automated or procedural techniques, data-driven/capture-based approaches, and/or hybrid techniques, among others. In some embodiments, these source content items can be manually prepared by an artist or content creator through digital illustration, painting, modeling, and/or other human-driven design processes, among others, particularly for textual content items, branding elements, and/or stylized volumetric representations. Alternatively, or in addition to, these source content items can be produced through virtual camera-based rendering pipelines, where perspective, orthographic, fisheye, panoramic, and/or stereoscopic projections, among others, can be applied to simulate how viewers situated at the real-world viewing points 108.1 through 108.n would perceive the real-world content items 104.1 through 104.n. Alternatively, or in addition to, these source content items can be generated procedurally or algorithmically, for example, through graphics engines, shader programs, simulations of lighting and environmental effects, or by using artificial intelligence models, among others, to extrapolate unseen viewpoints or transform two-dimensional inputs into three-dimensional virtual renderings. Alternatively, or in addition to, these source content items can be generated from data-driven or capture-based approaches, such as photogrammetry, LiDAR scans, point cloud reconstruction, voxel models, and/or light field capture, among others, which allow volumetric video, holograms, and/or augmented reality (AR) experiences to be reprojected into virtual renderings from multiple perspectives. Alternatively, or in addition to, these source content items can be generated from hybrid techniques, wherein captured datasets are combined with procedural stylization or artist-prepared assets, such as compositing LiDAR point clouds with textures, or reprojecting captured imagery onto synthetic geometry to create flexible and visually coherent virtual renderings.

In the exemplary embodiment illustrated in FIG. 1, the content mapping server 102 can transform the source content items into the real-world content items 104.1 through 104.n for mapping onto the three-dimensional physical surfaces 110.1 through 110.n of the real-world venue 106. In some embodiments, the content mapping server 102 can perform coordinate system transformations on the source content items to map them from two-dimensional content space, for example, pixel or UV coordinates, to real-world coordinates corresponding to the three-dimensional physical surfaces 110.1 through 110.n, thereby deriving the real-world content items 104.1 through 104.n. In these embodiments, the content mapping server 102 can apply intermediate mappings through spherical, cylindrical, or other parametric coordinate systems, optionally including normalization or scaling adjustments, to ensure accurate alignment and placement of the real-world content items 104.1 through 104.n on the three-dimensional physical surfaces 110.1 through 110.n. In some embodiments, the content mapping server 102 can further employ inverse mapping, ray casting, and/or camera-based distortion correction techniques, among others, to compensate for geometric distortions and preserve visual fidelity when rendering the real-world content items 104.1 through 104.n.

As illustrated in FIG. 1, the content mapping server 102 can map the real-world content items 104.1 through 104.n onto the three-dimensional physical surfaces 110.1 through 110.n of the real-world venue 106. In some embodiments, the three-dimensional physical surfaces 110.1 through 110.n can be represented as meshes, parametric surfaces, or point clouds, capturing surface geometry, curvature, and discontinuities, among others. In some embodiments, the content mapping server 102 can compute spatial correspondences between the real-world content items 104.1 through 104.n and the three-dimensional physical surfaces 110.1 through 110.n. In these embodiments, the spatial correspondences can refer to the relationships between points, regions, or features in the real-world content items 104.1 through 104.n and specific locations on the three-dimensional physical surfaces 110.1 through 110.n of the real-world venue 106. Generally, computing these spatial correspondences involves determining how each pixel, vertex, or element of the real-world content items 104.1 through 104.n maps to specific locations on the three-dimensional physical surfaces 110.1 through 110.n of the real-world venue 106, taking into account surface geometry, orientation, curvature, and/or any discontinuities, among others, of the real-world venue 106. In these embodiments, the content mapping server 102 can compute the spatial correspondences using, for example, homography transformations, UV mapping, mesh-based projections, or other suitable geometric mapping techniques, optionally leveraging plane detection or feature matching to accurately align the real-world content items 104.1 through 104.n with the three-dimensional physical surfaces 110.1 through 110.n of the real-world venue 106. In some embodiments, the content mapping server 102 can apply photometric adjustments, such as brightness, contrast, gamma correction, and/or color calibration, among others, to account for variations in ambient light and ensure that real-world content items 104.1 through 104.n appears visually consistent across the three-dimensional physical surfaces 110.1 through 110.n. In these embodiments, the content mapping server 102 can also incorporate anti-aliasing, resampling, or interpolation methods, among others, to accommodate differences in resolution between the real-world content items 104.1 through 104.n and the characteristics of the three-dimensional physical surfaces 110.1 through 110.n to avoid, or reduce, visual distortions and/or artifacts, among others. In some embodiments, the content mapping server 102 can perform this mapping in real-time, or near real-time, for dynamic or interactive content items, with buffering or streaming strategies to support continuous updates, while in other embodiments, the mapping can be precomputed for static installations.

In the exemplary embodiment illustrated in FIG. 1, the content mapping server 102 can coordinate multiple viewing points from among the real-world viewing points 108.1 through 108.n to ensure that the real-world content items 104.1 through 104.n appear coherent and immersive from these viewing points, applying blending or stitching techniques, among others, as needed. In some embodiments, the content mapping server 102 can stitch the real-world content items 104.1 through 104.n together across the three-dimensional physical surfaces 110.1 through 110.n to provide a continuous, or near-continuous, display of the real-world content items 104.1 through 104.n from the real-world viewing points 108.1 through 108.n in the real-world environment 100. In these embodiments, the content mapping server 102 can perform multi-input blending, wherein multiple source content items can be blended across the three-dimensional physical surfaces 110.1 through 110.n using rotoshapes, masks, alpha blending, gradient or feathering transitions, compositing layers, edge blending, texture splatting, shader-based techniques, procedural blending, and/or other suitable methods, among others, to ensure a seamless, visually coherent output. In some embodiments, the real-world content items 104.1 through 104.n, when mapped across the three-dimensional physical surfaces 110.1 through 110.n, can exhibit gaps, separations, or misalignments between two or more real-world content items from among the real-world content items 104.1 through 104.n. To compensate for such discontinuities, the content mapping server 102 can adjust, for example, the alignment, the scaling, the cropping, and/or rotation, among others, of the real-world content items 104.1 through 104.n. Alternatively, or in addition, the content mapping server 102 can fill, blur, pad, or overlay gradients or patterns onto these gaps to visually unify the real-world content items 104.1 through 104.n across the three-dimensional physical surfaces 110.1 through 110.n. In some embodiments, the content mapping server 102 can tile such patterns or gradients to seamlessly integrate them with adjacent real-world content items from among the real-world content items 104.1 through 104.n. The content mapping server 102 can perform these operations using techniques for displaying content items on real-world structures as described in U.S. patent application Ser. No. 18/341,464, filed Jun. 26, 2023, which is incorporated herein by reference in its entirety.

In the exemplary embodiment illustrated in FIG. 1, the content mapping server 102 can cause the real-world content items 104.1 through 104.n to be displayed on the real-world venue 106. In some embodiments, the content mapping server 102 can provide rendering instructions, image streams, and/or projection control signals, among others, to one or more display devices associated with the real-world venue 106, such as projectors, LED panels, or other display apparatuses, to present the real-world content items 104.1 through 104.n onto the three-dimensional physical surfaces 110.1 through 110.n. In these embodiments, the content mapping server 102 can synchronize the real-world content items 104.1 through 104.n across the three-dimensional physical surfaces 110.1 through 110.n to ensure temporal consistency and reduce visible artifacts such as flickering or tearing. In some embodiments, the content mapping server 102 can dynamically adjust display parameters, such as brightness, color balance, or refresh rate, based on environmental conditions or sensor feedback from the real-world venue 106. In some embodiments, the content mapping server 102 can cache or pre-load portions of the real-world content items 104.1 through 104.n to reduce latency and support seamless transitions during live events.

Exemplary Rendering-Based Mapping of Exemplary Real-World Content Items onto the Exemplary Real-World Structure

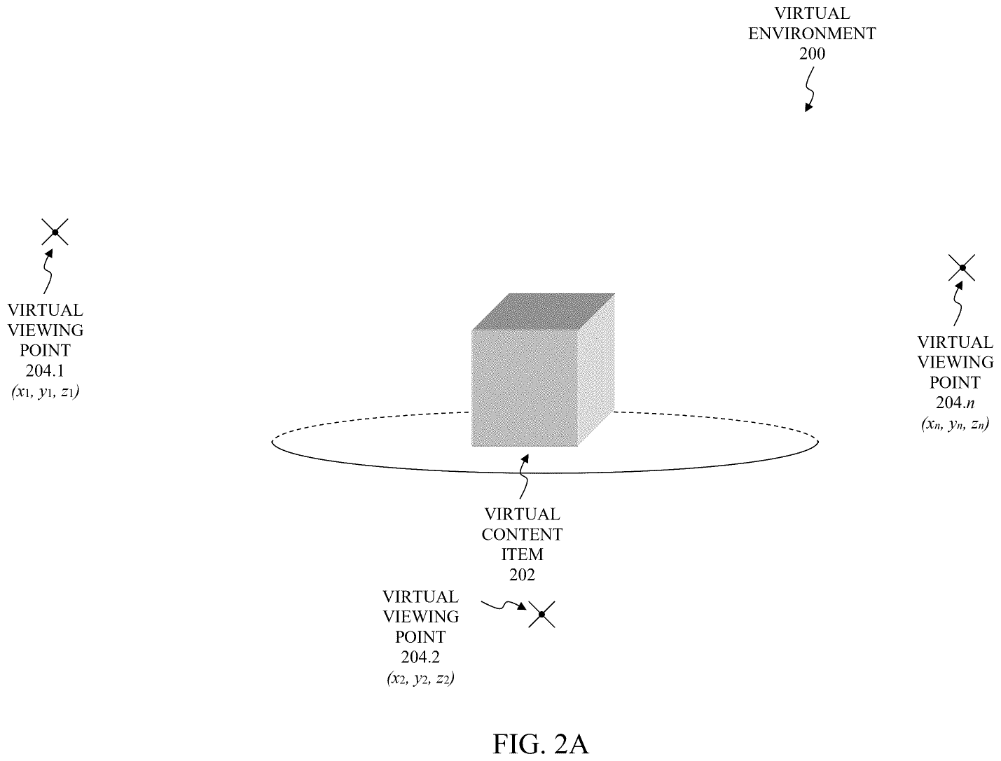

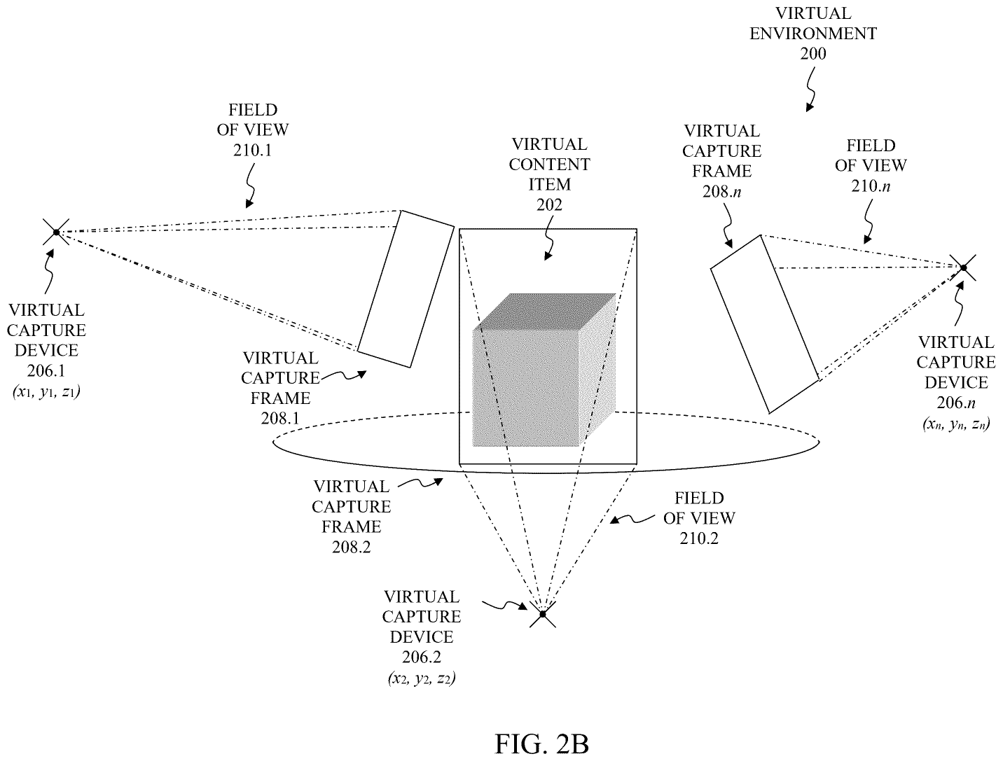

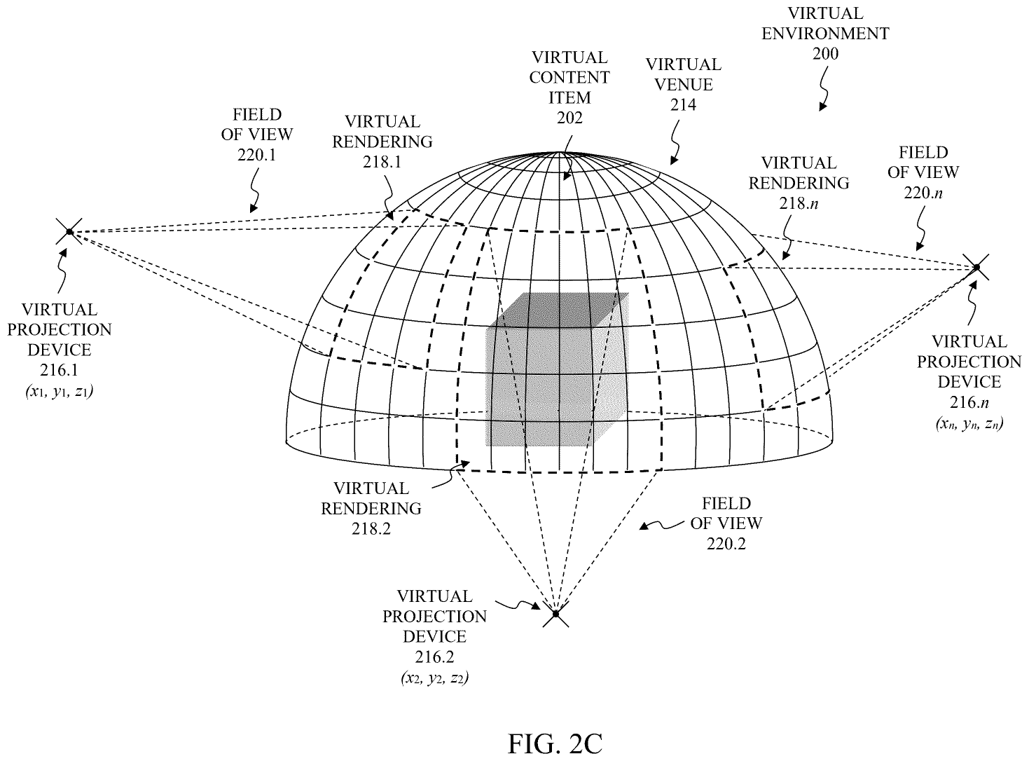

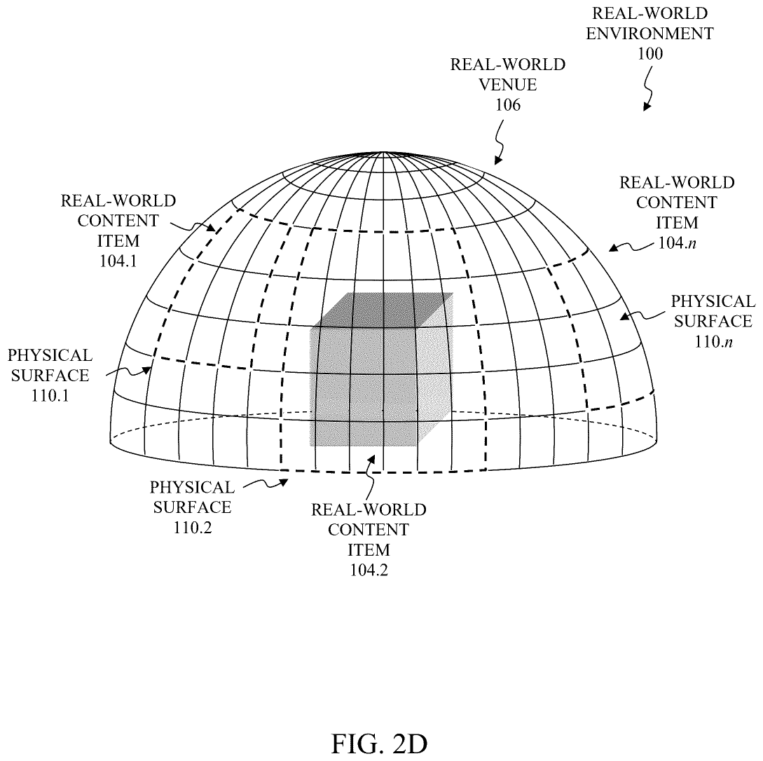

FIG. 2A through FIG. 2D graphically illustrate exemplary rendering-based mapping of exemplary real-world content items onto the exemplary real-world structure according to some exemplary embodiments of the present disclosure. In the exemplary embodiments illustrated in FIG. 2A through FIG. 2D, one or more computing systems, such as the content mapping server 102 described herein, can incorporate a rendering-based mapping to strategically capture the real-world content items 104.1 through 104.n from multiple locations within the real-world environment 100 and map the real-world content items 104.1 through 104.n onto the real-world venue 106. Generally, the one or more computing systems, an exemplary embodiment of which is to be described in further detail below, can incorporate the rendering-based mapping to map the real-world content items 104.1 through 104.n onto the real-world venue 106 to create an immersive visual experience that can be beneficially observed from the real-world viewing points 108.1 through 108.n as described herein.

As illustrated FIG. 2A, the one or more computing systems can access one or more of the source content items described herein in a virtual environment 200 to provide a virtual content item 202. In some embodiments, the virtual content item 202 can be characterized as being a computer-generated model of these source content items in the virtual environment 200. In these embodiments, the one or more computing systems can model these source content items in the virtual environment 200 to develop the virtual content item 202. In some embodiments, the one or more computing systems can estimate three-dimensional surfaces of these source content items to develop corresponding three-dimensional surfaces for the virtual content item 202 in terms of three-dimensional shapes, for example, cubes, spheres, and/or cylinders, among others, in the virtual environment 200. In these embodiments, the one or more computing systems can further develop these corresponding three-dimensional surfaces for the virtual content item 202 to include, for example, coloring, texture mapping, shading, and/or lighting, among others, to provide some examples. In some embodiments, the one or more computing systems can place the virtual content item 202 within the virtual environment 200 as illustrated in FIG. 2A. In these embodiments, the one or more computing systems can position, for example, move, rotate, and/or scale, among others, the virtual content item 202 within the virtual environment 200. Alternatively, or in addition to, the one or more computing systems can apply coloring, texture mapping, shading, and/or lighting, among others, to provide some examples to the virtual content item 202 within the virtual environment 200. In some embodiments, the one or more computing systems can execute any suitable game engine, for example, Unity, Unreal Engine, and/or Godot among others, that will be apparent to those skilled in the relevant art(s) to develop the virtual content item 202 as described herein without departing from the spirit and scope of the present disclosure.

As illustrated in FIG. 2A, the one or more computing systems can identify virtual viewing points 204.1 through 204.n within the virtual environment 200 that correspond to the real-world viewing points 108.1 through 108.n within the real-world environment 100. In some embodiments, the one or more computing systems can treat the virtual viewing points 204.1 through 204.n as virtualized observation nodes within the virtual environment 200, characterized by parameters such as fields of view, near and far clipping planes, depth ranges, and/or eye separation distances in stereoscopic configurations. By parameterizing the virtual viewing points 204.1 through 204.n in this manner, the one or more computing systems can accurately simulate how the virtual viewers virtually located at the virtual viewing points 204.1 through 204.n would perceive the virtual content item 202. In some embodiments, the virtual viewing points 204.1 through 204.n can be expressed as three-dimensional locations within the virtual environment 200 for observing the virtual content item 202. For example, the virtual viewing points 204.1 through 204.n can include ground-level views, bird's-eye view, worm's-eye view, aerial views, panoramic views, and/or isometric views, among others, of the real-world content items 104.1 through 104.n. As illustrated in FIG. 2A, the virtual viewing points 204.1 through 204.n can include a first virtual viewing point 204.1 having three-dimensional coordinates (x₁, y₁, z₁) in a Cartesian coordinate system, a second virtual viewing point 204.2 having three-dimensional coordinates (x₂, y₂, z₂) in the Cartesian coordinate system, and/or an n^{th} virtual viewing point 204.1 having three-dimensional coordinates (xₙ, yₙ, zₙ) in the Cartesian coordinate system. Although the virtual viewing points 204.1 through 204.n are illustrated in FIG. 2A as including these virtual viewing points, this is for exemplary purposes only and not limiting. Those skilled in the relevant art(s) will recognize the virtual viewing points 204.1 through 204.n can range from a single viewing point to tens, hundreds, and even more viewing points without departing from the spirit and scope of the present disclosure. And although the virtual viewing points 204.1 through 204.n are illustrated in the Cartesian coordinate system in FIG. 2A, those skilled in the relevant art(s) will recognize that virtual viewing points 204.1 through 204.n can be similarly represented in other coordinate systems, such as spherical and/or cylindrical, among others, to provide some examples, without departing from the spirit and scope of the present disclosure.

In the exemplary embodiment illustrated in FIG. 2B, the one or more computer systems can capture the virtual content item 202 at the virtual viewing points 204.1 through 204.n in the virtual environment 200 to provide virtual capture frames 208.1 through 208.n in the rendering-based mapping. The virtual capture frames 208.1 through 208.n can include one or more still images, sequential frames, and/or continuous video streams, among others. In some embodiments, the one or more computer systems can implement a rendering pipeline that instantiates virtual capture devices 206.1 through 206.n at, or near, the virtual viewing points 204.1 through 204.n in the virtual environment 200, each virtual camera from among the virtual capture devices 206.1 through 206.n capturing a unique rendering of the virtual content item 202. The virtual capture devices 206.1 through 206.n can be parameterized by three-dimensional position, orientation vectors, field-of-view, focal length, depth-of-field, aperture, and/or lens distortion characteristics, among others, to simulate how virtual viewers situated at the virtual viewing points 204.1 through 204.n would perceive the virtual content item 202. In some embodiments, the virtual capture devices 206.1 through 206.n can be implemented as virtual cameras that represent simulated capture devices within the virtual environment 200 to capture the multiple renderings of the virtual content item 202 in substantially similar manner as physical cameras within the real-world environment 100. As illustrated in FIG. 2B, the virtual capture devices 206.1 through 206.n can capture the multiple renderings of the virtual content item 202 within fields of view 210.1 through 210.n to provide the virtual capture frames 208.1 through 208.n. In some embodiments, a corresponding field of view from among the fields of view 210.1 through 210.n for a corresponding virtual camera from among the virtual capture devices 206.1 through 206.n can be estimated as:

$$α = 2 \times {tan}^{- 1} \frac{L}{2 D} , and \qquad ( 1 )$$

$$β = 2 \times {tan}^{- 1} \frac{W}{2 D} , \qquad ( 2 )$$

where α represents a vertical angle about a x-z plane of a Cartesian coordinate system between a corresponding virtual viewing point from among the virtual viewing points 204.1 through 204.n and the virtual content item 202, β represents a horizontal angle about a x-y plane of the Cartesian coordinate system between the corresponding virtual viewing point and the virtual content item 202, L represents a vertical length of a corresponding virtual view from among the virtual capture frames 208.1 through 208.n about the z-axis of the Cartesian coordinate system, W represents a horizontal width of the corresponding virtual view about a y-axis of the Cartesian coordinate system, and D represents the distance between the corresponding virtual viewing point and the virtual content item 202 along the x-axis of the Cartesian coordinate system. Although the fields of view 210.1 through 210.n are illustrated as being rectangular fields of view, those skilled in the relevant art(s) will recognize that other fields of view are possible, such as circular fields of view, panoramic fields of view, anamorphic fields of view, fish-eye fields of view, and/or catadioptric fields of view, among others, are possible without departing from the spirit and scope of the present disclosure.

In the exemplary embodiment illustrated in FIG. 2C, the one or more computing systems can transform the virtual capture frames 208.1 through 208.n to generate virtual renderings 218.1 through 218.n of the virtual content item 202 in the virtual environment 200. In some embodiments, these transformations ensure that the virtual content item 202 is accurately and consistently represented when displayed in the virtual environment 200. Without these transformations, geometric distortions, misaligned depth, or incorrect occlusions could occur due to the spatial configuration of the real-world venue 106, which can lead to a degraded or confusing viewing experience. Additionally, photometric differences such as variations in color, brightness, and contrast could cause the virtual content item 202 to appear unnatural or inconsistent across the virtual viewing points 204.1 through 204.n. By applying geometric, photometric, and/or viewer-specific adjustments, among others, the one or more computing systems ensure that the virtual viewing points 204.1 through 204.n perceive coherent, immersive, and visually accurate renderings of the virtual content item 202, regardless of their location or angle of view, thereby preserving both the aesthetic quality and the immersive experience intended for the virtual content item 202.

In some embodiments, the one or more computing systems can transform the virtual capture frames 208.1 through 208.n from two-dimensional image space coordinates onto three-dimensional virtual space coordinates of the virtual venue 214 for display in the virtual environment 200. In these embodiments, the one or more computing systems can implement a multi-step transformation process to transform the virtual capture frames 208.1 through 208.n from the two-dimensional image space coordinates onto the three-dimensional virtual space coordinates of the virtual venue 214. In some embodiments, the virtual capture frames 208.1 through 208.n can be expressed in two-dimensional image space coordinates, for example, pixel coordinates (x, y) in a Cartesian coordinate system. In some embodiments, the one or more computing systems can map the virtual capture frames 208.1 through 208.n from the pixel coordinates (x, y) onto normalized UV coordinates of a UV coordinate system, which ranges from 0 to 1, that corresponds to the three-dimensional geometry of the virtual venue 214. In these embodiments, this normalizing of the pixel coordinates (x, y) converts resolution-dependent pixel positions into a universal, geometry-friendly UV coordinate system that can then be mapped onto the virtual venue 214. Generally, the one or more computing systems can map the virtual capture frames 208.1 through 208.n from the pixel coordinates (x, y) into the normalized UV coordinates according to:

$$U = \frac{x}{W - 1} , and \qquad ( 3 )$$

$$V = \frac{y}{H - 1} , \qquad ( 4 )$$

wherein W and H represent the width and the height, respectively, of the virtual capture frames 208.1 through 208.n in pixels.

In some embodiments, the one or more computing systems can remap the virtual capture frames 208.1 through 208.n from the normalized UV coordinates into spherical coordinates (θ, φ) of a spherical coordinate system. In these embodiments, the one or more computing systems can remap the virtual capture frames 208.1 through 208.n from the normalized UV coordinates onto the spherical coordinates (θ, φ) using a spherical transform (ST) map. In these embodiments, this remapping generates “warped” representations of the virtual capture frames 208.1 through 208.n, which may appear stretched or compressed in two dimensions, to ensure that the virtual capture frames 208.1 through 208.n align and display correctly on the virtual venue 214. Generally, the one or more computing systems can map the virtual capture frames 208.1 through 208.n from the normalized UV coordinates onto the spherical coordinates (θ, φ) according to:

$$θ = 2 π u , and \qquad ( 5 )$$

$$φ = π v , \qquad ( 6 )$$

wherein the longitude θ refers to a circumference around the virtual venue 214 and the latitude φ refers to a height of the virtual venue 214.

In some embodiments, the one or more computing systems can remap the virtual capture frames 208.1 through 208.n from the spherical coordinates (θ, φ) to three-dimensional coordinates (x′, y′, z′) of the Cartesian coordinate system to generate the virtual renderings 218.1 through 218.n. Generally, the one or more computing systems can map the virtual capture frames 208.1 through 208.n from the spherical coordinates (θ, φ) to the three-dimensional coordinates (x′, y′, z′) according to:

$${x}^{′} = sin φ cos θ , \qquad ( 7 )$$

$${y}^{′} = sin φ sin θ , \qquad ( 8 )$$

$${z}^{′} = cos φ . \qquad ( 9 )$$

In some embodiments, through this sequence of mappings, from pixel space to normalized UV space, to spherical coordinates, and finally to Cartesian coordinates, the one or more computing systems can accurately place the virtual capture frames 208.1 through 208.n onto the three-dimensional geometry of the virtual venue 214 for realistic display in the virtual environment 200.

In the exemplary embodiment illustrated in FIG. 2C, the one or more computing systems can map the virtual renderings 218.1 through 218.n onto the virtual venue 214 in the virtual environment 200. As illustrated in FIG. 2C, the one or more computing systems can access a virtual representation of the real-world venue 106 in the virtual environment 200 to provide the virtual venue 214. In some embodiments, the virtual venue 214 can be characterized as being a computer-generated model of the real-world venue 106 in the virtual environment 200. In these embodiments, the one or more computing systems can model the real-world venue 106 in the virtual environment 200 to develop the virtual venue 214. In some embodiments, the one or more computing systems can estimate the three-dimensional physical surfaces 110.1 through 110.n of the real-world venue 106 within the real-world environment 100 to develop corresponding three-dimensional surfaces for the virtual venue 214 in terms of three-dimensional shapes, for example, cubes, spheres, and/or cylinders, among others, in the virtual environment 200. In these embodiments, the one or more computing systems can further develop these corresponding three-dimensional surfaces for the virtual venue 214 to include, for example, coloring, texture mapping, shading, and/or lighting, among others, to provide some examples. In some embodiments, the one or more computing systems can place the virtual venue 214 within the virtual environment 200 as illustrated in FIG. 2C. In these embodiments, the one or more computing systems can position, for example, move, rotate, and/or scale, among others, the virtual venue 214 within the virtual environment 200. Alternatively, or in addition to, the one or more computing systems can apply coloring, texture mapping, shading, and/or lighting, among others, to provide some examples to the virtual venue 214 within the virtual environment 200. In some embodiments, the one or more computing systems can execute any suitable game engine, for example, Unity, Unreal Engine, and/or Godot, among others, that will be apparent to those skilled in the relevant art(s) to develop the virtual venue 214 as described herein without departing from the spirit and scope of the present disclosure.

After accessing the virtual venue 214, the one or more computing systems can map the virtual renderings 218.1 through 218.n onto the virtual venue 214 in the virtual environment 200. In some embodiments, the mapping can include computing a spatial correspondence between the virtual renderings 218.1 through 218.n and three-dimensional virtual space coordinates of the virtual venue 214. In these embodiments, the one or more computing systems can project, or texture-map, the virtual renderings 218.1 through 218.n onto these surfaces by applying homography transformations, rendering warping, and/or UV-mapping techniques, among others, that align the virtual renderings 218.1 through 218.n with the virtual layout of the virtual venue 214. For example, the one or more computing systems can position virtual projection devices 216.1 through 216.n within the virtual environment 200 that correspond to the virtual viewing points 204.1 through 204.n to project the three-dimensional coordinates of the virtual renderings 218.1 through 218.n from the virtual viewing points 204.1 through 204.n onto the three-dimensional surfaces of the virtual venue 214 in the virtual environment 200. In this example embodiments, the virtual projection devices 216.1 through 216.n can be implemented as virtual projectors that represent simulated projection devices within the virtual environment 200 to project the virtual renderings 218.1 through 218.n in substantially similar manner as physical projection devices within the real-world environment 100. In some embodiments, the one or more computing systems can also compensate for surface curvature, uneven geometries, or occluded regions by applying non-linear warping functions or mesh-based projection models. Alternatively, or in addition to, the one or more computing systems can apply photometric corrections to account for ambient lighting conditions within the real-world environment 100 and/or the virtual environment 200, ensuring that brightness, color, and contrast of the virtual content item 202 are consistent across the virtual venue 214. Through these mapping operations, the virtual renderings 218.1 through 218.n are seamlessly mapped on the virtual venue 214 to enable the virtual content item 202 to be perceived as if the virtual content item 202 were naturally situated within the spatial and/or the visual context of the virtual venue 214.

In the exemplary embodiment illustrated in FIG. 2D, the one or more computing systems can transform the virtual renderings 218.1 through 218.n from the virtual environment 200 into the real-world content items 104.1 through 104.n that are mapped onto the three-dimensional physical surfaces 110.1 through 110.n of the real-world venue 106 in the real-world environment 100. In these embodiments, the three-dimensional physical surfaces 110.1 through 110.n of the real-world venue 106 function as display surfaces for the real-world content items 104.1 through 104.n. For example, the real-world venue 106 can include a three-dimensional display structure configured as a curved, continuous display surface that envelops the real-world venue 106. In some embodiments, the one or more computing systems can adapt and/or align the real-world content items 104.1 through 104.n onto the three-dimensional physical surfaces 110.1 through 110.n. In these embodiments, the one or more computing systems can identify the coordinates, scales, and/or orientations of the real-world content items 104.1 through 104.n that have been mapped onto the three-dimensional physical surfaces 110.1 through 110.n. After identifying these parameters, the one or more computing systems can translate the coordinates, scales, and/or orientations of the virtual renderings 218.1 through 218.n from the virtual environment 200 into corresponding coordinates, scales, and/or orientations of the real-world content items 104.1 through 104.n. In some embodiments, the mapping can include computing a spatial correspondence between two-dimensional coordinates of the virtual renderings 218.1 through 218.n and three-dimensional coordinates of the real-world content items 104.1 through 104.n. The one or more computing systems can apply homography transformations, rendering warping, or mesh-based mapping functions, among others, to the real-world content items 104.1 through 104.n to compensate for curvature, irregular geometries, or discontinuities across the three-dimensional physical surfaces 110.1 through 110.n. Additionally, the one or more computing systems can utilize plane detection algorithms to identify and segment the three-dimensional physical surfaces 110.1 through 110.n of the real-world venue 106 that are to display the real-world content items 104.1 through 104.n. Alternatively, or in addition, the one or more computing systems can apply photometric corrections to the real-world content items 104.1 through 104.n to account for brightness, contrast, shadows, and ambient lighting conditions within the real-world environment 100, ensuring that the real-world content items 104.1 through 104.n appear visually consistent across the three-dimensional physical surfaces 110.1 through 110.n. Through these transformation and mapping operations, the one or more computing systems seamlessly present the real-world content items 104.1 through 104.n on the three-dimensional physical surfaces 110.1 through 110.n of the real-world venue 106, such that the real-world content items 104.1 through 104.n is perceived as naturally integrated within the spatial and visual context of the real-world environment 100.

In some embodiments, the one or more computing systems can cause the real-world content items 104.1 through 104.n to be displayed on the real-world venue 106. In some embodiments, the one or more computing systems can provide rendering instructions, image streams, and/or projection control signals, among others, to one or more display devices associated with the real-world venue 106, such as projectors, LED panels, or other display apparatuses, to present the real-world content items 104.1 through 104.n onto the three-dimensional physical surfaces 110.1 through 110.n. In these embodiments, the one or more computing systems can synchronize the real-world content items 104.1 through 104.n across the three-dimensional physical surfaces 110.1 through 110.n to ensure temporal consistency and reduce visible artifacts such as flickering or tearing. In some embodiments, the one or more computing systems can dynamically adjust display parameters, such as brightness, color balance, or refresh rate, based on environmental conditions or sensor feedback from the real-world venue 106. In some embodiments, the one or more computing systems can cache or pre-load portions of the real-world content items 104.1 through 104.n to reduce latency and support seamless transitions during live events.

### Exemplary Operational Control Flow for the Exemplary Rendering-Based Mapping

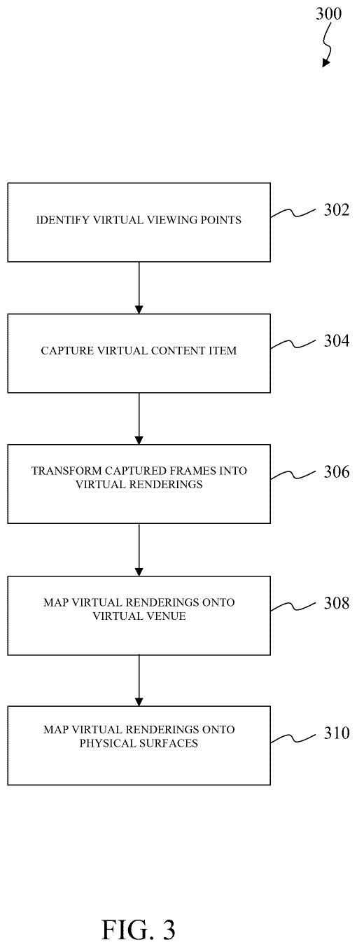

FIG. 3 illustrates an exemplary operational control flow for the exemplary rendering-based mapping of exemplary real-world content items onto the exemplary real-world venue according to some exemplary embodiments of the present disclosure. The following discussion describes an exemplary operational control flow 300 for displaying one or more real-world content items, such as the real-world content items 104.1 through 104.n to provide an example, from real-world viewing points, such as the real-world viewing points 108.1 through 108.n to provide an example, onto a real-world venue, such as the real-world venue 106 to provide an example, in a real-world environment. The present disclosure is not limited to these exemplary operational control flows. Rather, it will be apparent to those skilled in the relevant art(s) that other operational control flows are within the scope and spirit of the present disclosure. In some embodiments, the operational control flow 300 can be performed by one or more computing systems, such as the content mapping server 102 described herein. Generally, the one or more computing systems can map the real-world content items across physical surfaces of the real-world venue, such as three-dimensional physical surfaces 110.1 through 110.n of the real-world venue 106 to provide an example, to create an immersive visual experience that can be beneficially observed from the real-world viewing points as described herein.

At operation 302, the operational control flow 300 identifies virtual viewing points, such as the virtual viewing points 204.1 through 204.n, within a virtual environment that correspond to the real-world viewing points as described herein. In some embodiments, the virtual viewing points can be expressed as three-dimensional locations for observing multiple renderings of one or more virtual content items, such as the virtual content item 202, that have been mapped onto a virtual venue, such as the virtual venue 214, as described herein.

At operation 304, the operational control flow 300 captures the one or more virtual content items from operation 302 from the virtual viewing points to provide virtual capture frames, such as the virtual capture frames 208.1 through 208.n, as described herein. In some embodiments, the operational control flow 300 can instantiate virtual capture devices at or near the virtual viewing points, parameterized to simulate real-world camera characteristics including position, orientation, field of view, focal length, depth-of-field, and lens distortion as described herein.

At operation 306, the operational control flow 300 transforms the captured virtual frames from operation 304 from two-dimensional image space coordinates onto three-dimensional virtual space coordinates of the virtual venue to generate virtual renderings, such as the virtual renderings 218.1 through 218.n, as described herein. This transformation ensures accurate placement, depth, and visual consistency of the one or more virtual content items from operation 302 in the virtual environment as described herein.

At operation 308, the operational control flow 300 maps the virtual renderings from operation 306 onto the surfaces of the virtual venue as described herein. The operational control flow 300 can compute spatial correspondences and apply homography transformations, rendering warping, and/or UV-mapping techniques to align the virtual renderings with the geometry of the virtual venue as described herein. In some embodiments, the operational control flow 300 can instantiate virtual projection devices to project the virtual renderings from operation 306 onto the surfaces of the virtual venue. In these embodiments, the operational control flow 300 can apply photometric corrections to maintain consistent brightness, contrast, and color across the virtual venue as described herein.

At operation 310, the operational control flow 300 transforms the virtual renderings from operation 306 to provide the one or more real-world content items for mapping onto three-dimensional physical surfaces of the real-world venue, such as the three-dimensional physical surfaces 110.1 through 110.n of the real-world venue 106, in the real-world environment as described herein. The operational control flow 300 can adapt and/or align the coordinates, scales, and orientations of the virtual renderings to the three-dimensional physical surfaces, compensating for curvature, scale, and lighting conditions to provide the real-world renderings as described herein. In these embodiments, the operational control flow 300 can apply plane detection, mesh-based mapping, and/or photometric correction algorithms, among others, to ensure real-world renderings appear consistent and integrated across the physical surfaces, allowing the one or more real-world content items to be perceived as naturally integrated within the spatial and visual context of the real-world environment as described herein.

Exemplary Replication-Based Mapping of Exemplary Real-World Content Items onto the Exemplary Real-World Structure

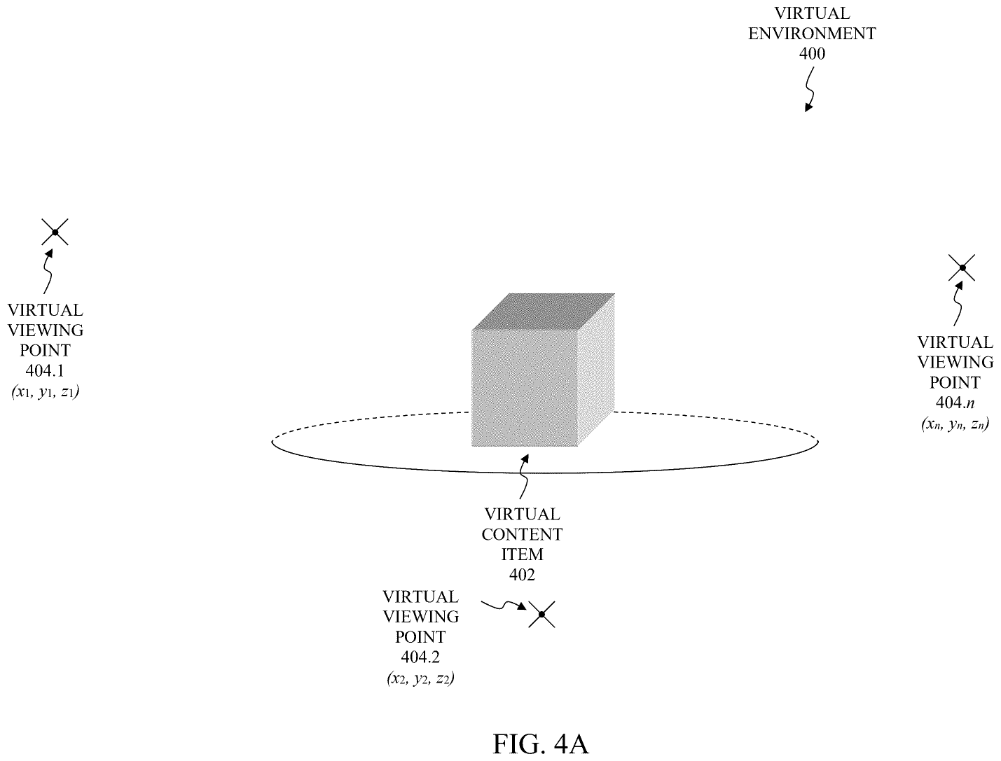

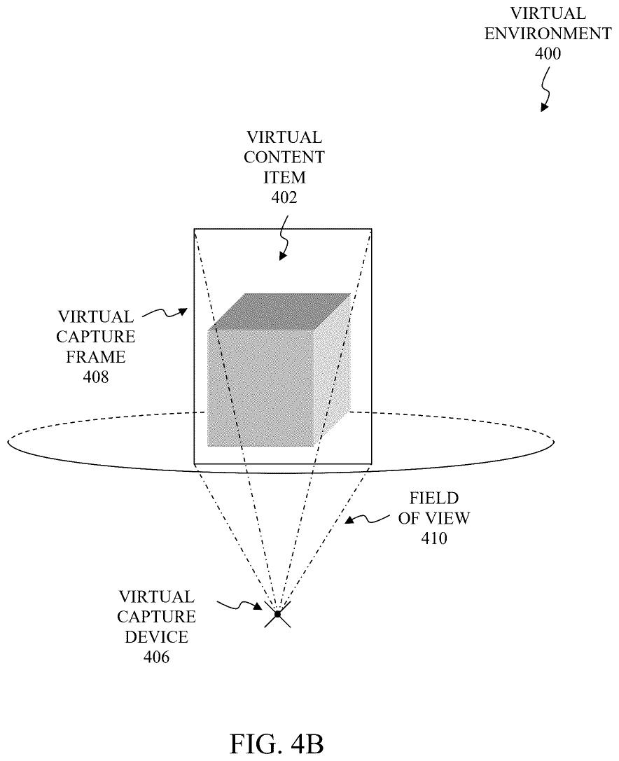

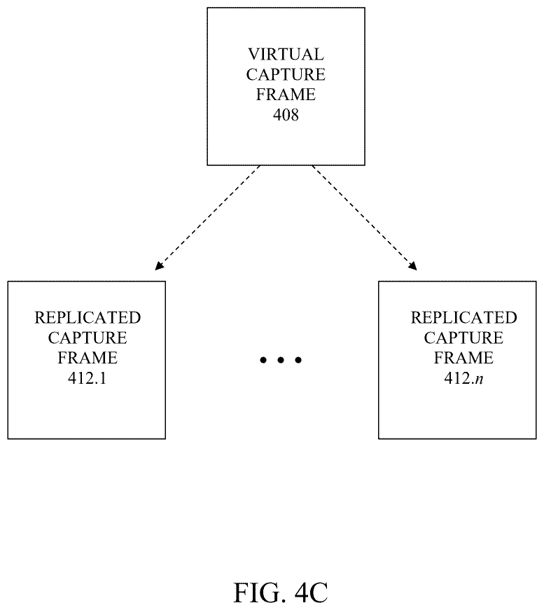

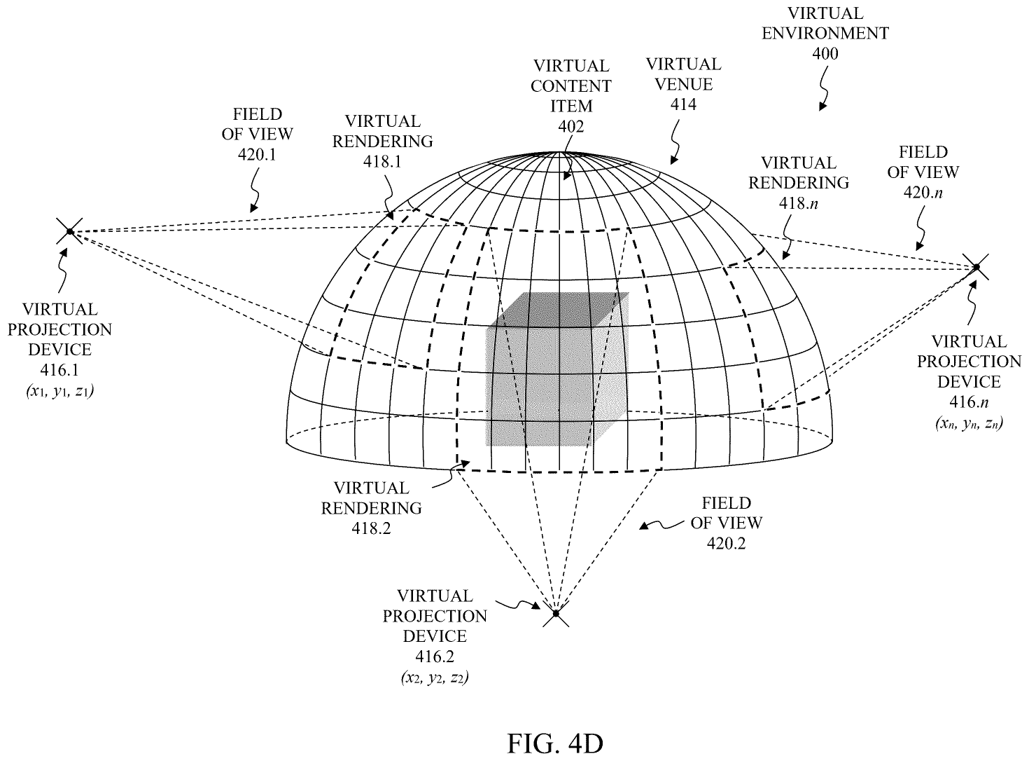

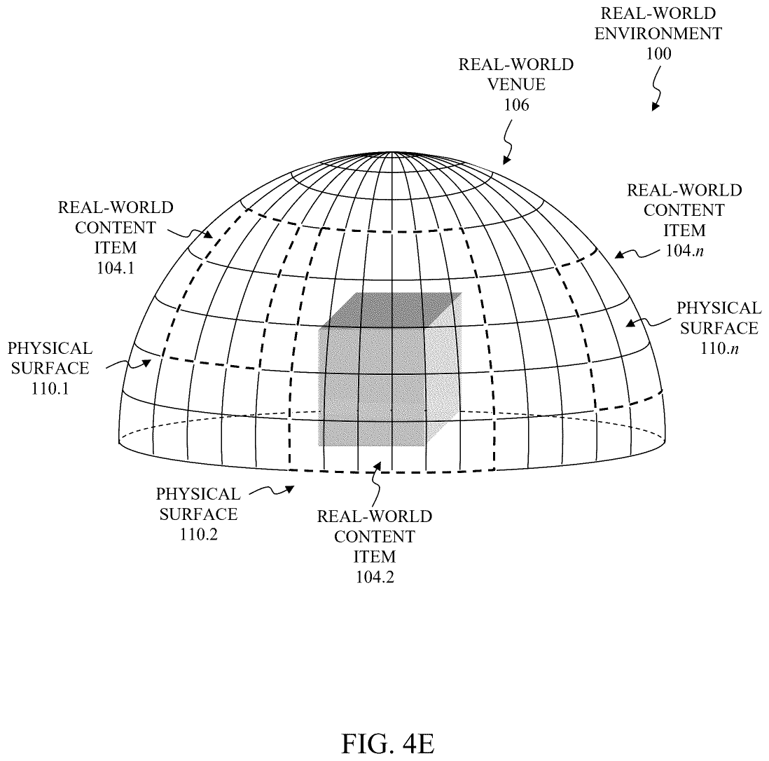

FIG. 4A through FIG. 4E graphically illustrate an exemplary replication-based mapping of exemplary real-world content items onto the exemplary real-world structure according to some exemplary embodiments of the present disclosure. In the exemplary embodiments illustrated in FIG. 4A through FIG. 4E, one or more computing systems, such as the content mapping server 102 described herein, can incorporate a replication-based mapping to strategically capture a single rendering of the real-world content items 104.1 through 104.n from one location within the real-world environment 100 and map replications of this single rendering across the real-world venue 106. Generally, the one or more computing systems, an exemplary embodiment of which is to be described in further detail below, can incorporate the replication-based mapping to replicate the single rendering of the real-world content items 104.1 through 104.n across the surfaces of the real-world venue 106 to create an immersive visual experience that extends uniformly across the real-world venue 106 that can be beneficially observed from the real-world viewing points 108.1 through 108.n as described herein.

As illustrated FIG. 4A, the one or more computing systems can access one or more of the source content items described herein in a virtual environment 400 to provide a virtual content item 402. In some embodiments, the virtual content item 402 can be characterized as being a computer-generated model of these source content items in the virtual environment 400. In these embodiments, the one or more computing systems can model these source content items in the virtual environment 400 to develop the virtual content item 402. In some embodiments, the one or more computing systems can estimate three-dimensional surfaces of these source content items to develop corresponding three-dimensional surfaces for the virtual content item 402 in terms of three-dimensional shapes, for example, cubes, spheres, and/or cylinders, among others, in the virtual environment 400. In these embodiments, the one or more computing systems can further develop these corresponding three-dimensional surfaces for the virtual content item 402 to include, for example, coloring, texture mapping, shading, and/or lighting, among others, to provide some examples. In some embodiments, the one or more computing systems can place the virtual content item 402 within the virtual environment 400 as illustrated in FIG. 4A. In these embodiments, the one or more computing systems can position, for example, move, rotate, and/or scale, among others, the virtual content item 402 within the virtual environment 400. Alternatively, or in addition to, the one or more computing systems can apply coloring, texture mapping, shading, and/or lighting, among others, to provide some examples to the virtual content item 402 within the virtual environment 400. In some embodiments, the one or more computing systems can execute any suitable game engine, for example, Unity, Unreal Engine, and/or Godot, among others, that will be apparent to those skilled in the relevant art(s) to develop the virtual content item 402 as described herein without departing from the spirit and scope of the present disclosure.

As illustrated in FIG. 4A, the one or more computing systems can identify virtual viewing points 404.1 through 404.n within the virtual environment 400 that correspond to the real-world viewing points 108.1 through 108.n within the real-world environment 100. In some embodiments, the one or more computing systems can treat the virtual viewing points 404.1 through 404.n as virtualized observation nodes within the virtual environment 400, characterized by parameters such as fields of view, near and far clipping planes, depth ranges, and/or eye separation distances in stereoscopic configurations. By parameterizing the virtual viewing points 404.1 through 404.n in this manner, the one or more computing systems can accurately simulate how the virtual viewers virtually located at the virtual viewing points 404.1 through 404.n would perceive the virtual content item 402. In some embodiments, the virtual viewing points 404.1 through 404.n can be expressed as three-dimensional locations within the virtual environment 400 for observing the virtual content item 402. For example, the virtual viewing points 404.1 through 404.n can include ground-level views, bird's-eye view, worm's-eye view, aerial views, panoramic views, and/or isometric views, among others, of the real-world content items 104.1 through 104.n. As illustrated in FIG. 4A, the virtual viewing points 404.1 through 404.n can include a first virtual viewing point 404.1 having three-dimensional coordinates (x₁, y₁, z₁) in a Cartesian coordinate system, a second virtual viewing point 404.2 having three-dimensional coordinates (x₂, y₂, z₂) in the Cartesian coordinate system, and/or an n^{th} virtual viewing point 404.1 having three-dimensional coordinates (xₙ, yₙ, zₙ) in the Cartesian coordinate system. Although the virtual viewing points 404.1 through 404.n are illustrated in FIG. 4A as including these virtual viewing points, this is for exemplary purposes only and not limiting. Those skilled in the relevant art(s) will recognize the virtual viewing points 404.1 through 404.n can range from a single viewing point to tens, hundreds, and even more viewing points without departing from the spirit and scope of the present disclosure. And although the virtual viewing points 404.1 through 404.n are illustrated in the Cartesian coordinate system in FIG. 4A, those skilled in the relevant art(s) will recognize that virtual viewing points 404.1 through 404.n can be similarly represented in other coordinate systems, such as spherical and/or cylindrical, among others, to provide some examples, without departing from the spirit and scope of the present disclosure.

In the exemplary embodiment illustrated in FIG. 4B, the one or more computer systems can capture the virtual content item 402 at a single virtual viewing point from among the virtual viewing points 404.1 through 404.n in the virtual environment 400 to provide a virtual capture frame 408 in the replication-based mapping. The virtual capture frame 408 can include one or more still images, sequential frames, and/or continuous video streams, among others. In some embodiments, the one or more computer systems can implement a rendering pipeline that instantiates a virtual capture device 406 at, or near, the single virtual viewing point. The virtual capture device 406 can be parameterized by three-dimensional position, orientation vectors, field-of-view, focal length, depth-of-field, aperture, and/or lens distortion characteristics, among others, to simulate how a virtual viewer situated at the single virtual viewing point would perceive the virtual content item 402. In some embodiments, the virtual capture device 406 can be implemented as a virtual camera that represents a simulated capture device within the virtual environment 400 to capture the single rendering of the virtual content item 402 in substantially similar manner as physical cameras within the real-world environment 100. As illustrated in FIG. 4B, the virtual capture device 406 can capture the single rendering of the virtual content item 402 within a field of view 410 to provide the virtual capture frame 408. In some embodiments, the field of view 410 for the virtual capture device 406 can be estimated as:

$$α = 2 \times {tan}^{- 1} \frac{L}{2 D} , and \qquad ( 10 )$$

$$β = 2 \times {tan}^{- 1} \frac{W}{2 D} , , \qquad ( 11 )$$

where α represents a vertical angle about a x-z plane of a Cartesian coordinate system between the single virtual viewing point and the virtual content item 402, β represents a horizontal angle about a x-y plane of the Cartesian coordinate system between the single virtual viewing point and the virtual content item 402, L represents a vertical length of the virtual capture frame 408 about the z-axis of the Cartesian coordinate system, W represents a horizontal width of the virtual capture frame 408 about a y-axis of the Cartesian coordinate system, and D represents the distance between the single virtual viewing point and the virtual content item 402 along the x-axis of the Cartesian coordinate system. Although the field of view 410 is illustrated as being a rectangular field of view, those skilled in the relevant art(s) will recognize that other fields of view are possible, such as circular fields of view, panoramic fields of view, anamorphic fields of view, fish-eye fields of view, and/or catadioptric fields of view, among others, are possible without departing from the spirit and scope of the present disclosure.

In the exemplary embodiment illustrated in FIG. 4C, the one or more computing systems can replicate the virtual capture frame 408 of the virtual content item 402 to provide one or more replicated captured frames 412.1 through 412.n. In some embodiments, the one or more computing systems can copy the two-dimensional image data of the virtual capture frame 408 into multiple buffers to provide the one or more replicated captured frames 412.1 through 412.n. Each of the one or more replicated captured frames 412.1 through 412.n can correspond to a distinct surface region of the virtual venue 414, such as a polygonal face, curved patch, or panelized subdivision, among others. Alternatively, or in addition, the one or more computing systems can represent the virtual content item 402 as a hierarchical scene graph, having scene graph nodes corresponding to meshes, textures, lighting, and other visual properties. In some embodiments, the one or more computing systems can instantiate multiple copies of the scene graph nodes, associating each copy with a distinct surface region of the virtual venue 414. In some embodiments, instancing techniques can be used to store the virtual capture frame 408 in memory while rendering the virtual capture frame 408 multiple times with region-specific transformations, thereby reducing memory usage while preserving flexibility. Additionally, preliminary photometric or geometric corrections, such as brightness or contrast normalization and rendering adjustments, can be applied to the virtual capture frame 408 prior to replication to ensure that the replicated views 412.1 through 412.n integrate seamlessly onto the three-dimensional surfaces of the virtual venue 414.

In the exemplary embodiment illustrated in FIG. 4D, the one or more computing systems can transform the replicated captured frames 412.1 through 412.n to generate virtual renderings 418.1 through 418.n of the virtual content item 402 in the virtual environment 400. In some embodiments, these transformations ensure that the virtual content item 402 is accurately and consistently represented when displayed in the virtual environment 400. Without these transformations, geometric distortions, misaligned depth, or incorrect occlusions could occur due to the spatial configuration of the real-world venue 106, which can lead to a degraded or confusing viewing experience. Additionally, photometric differences such as variations in color, brightness, and contrast could cause the virtual content item 402 to appear unnatural or inconsistent across the virtual viewing points 404.1 through 404.n. By applying geometric, photometric, and/or viewer-specific adjustments, among others, the one or more computing systems ensure that the virtual viewing points 404.1 through 404.n perceive coherent, immersive, and visually accurate renderings of the virtual content item 402, regardless of their location or angle of view, thereby preserving both the aesthetic quality and the immersive experience intended for the virtual content item 402.

In some embodiments, the one or more computing systems can transform the replicated captured frames 412.1 through 412.n from two-dimensional image space coordinates onto three-dimensional virtual space coordinates of the virtual venue 414 for display in the virtual environment 400. In these embodiments, the one or more computing systems can implement a multi-step transformation process to transform the replicated captured frames 412.1 through 412.n from the two-dimensional image space coordinates onto the three-dimensional virtual space coordinates of the virtual venue 414. In some embodiments, the replicated captured frames 412.1 through 412.n can be expressed in two-dimensional image space coordinates, for example, pixel coordinates (x, y) in a Cartesian coordinate system. In some embodiments, the one or more computing systems can map the replicated captured frames 412.1 through 412.n from the pixel coordinates (x, y) onto normalized UV coordinates of a UV coordinate system, which ranges from 0 to 1, that corresponds to the three-dimensional geometry of the virtual venue 414. In these embodiments, this normalizing of the pixel coordinates (x, y) converts resolution-dependent pixel positions into a universal, geometry-friendly UV coordinate system that can then be mapped onto the virtual venue 414. Generally, the one or more computing systems can map the replicated captured frames 412.1 through 412.n from the pixel coordinates (x, y) into the normalized UV coordinates according to:

$$U = \frac{x}{W - 1} , and$$

wherein W and H represent the width and the height, respectively, of the replicated captured frames 412.1 through 412.n in pixels.

In some embodiments, the one or more computing systems can remap the replicated captured frames 412.1 through 412.n from the normalized UV coordinates into spherical coordinates (θ, φ) of a spherical coordinate system. In these embodiments, the one or more computing systems can remap the replicated captured frames 412.1 through 412.n from the normalized UV coordinates onto the spherical coordinates (θ, φ) using a spherical transform (ST) map. In these embodiments, this remapping generates “warped” representations of the replicated captured frames 412.1 through 412.n, which may appear stretched or compressed in two dimensions, to ensure that the replicated captured frames 412.1 through 412.n align and display correctly on the virtual venue 414. Generally, the one or more computing systems can map the replicated captured frames 412.1 through 412.n from the normalized UV coordinates onto the spherical coordinates (θ, φ) according to:

$$θ = 2 π u , and \qquad ( 14 )$$

$$φ = π v , \qquad ( 15 )$$

wherein the longitude θ refers to a circumference around the virtual venue 414 and the latitude φ refers to a height of the virtual venue 414.

In some embodiments, the one or more computing systems can remap the replicated captured frames 412.1 through 412.n from the spherical coordinates (θ, φ) to three-dimensional coordinates (x′, y′, z′) of the Cartesian coordinate system to generate the virtual renderings 418.1 through 418.n. Generally, the one or more computing systems can map the replicated captured frames 412.1 through 412.n from the spherical coordinates (θ, φ) to the three-dimensional coordinates (x′, y′, z′) according to:

$${x}^{′} = sin φ cos θ , \qquad ( 16 )$$

$${y}^{′} = sin φ sin θ , \qquad ( 17 )$$

$${z}^{′} = cos φ . \qquad ( 18 )$$

In some embodiments, through this sequence of mappings, from pixel space to normalized UV space, to spherical coordinates, and finally to Cartesian coordinates, the one or more computing systems can accurately place the replicated captured frames 412.1 through 412.n onto the three-dimensional geometry of the virtual venue 414 for realistic display in the virtual environment 400.

In some embodiments, the one or more computing systems can map the virtual renderings 418.1 through 418.n onto the virtual venue 414 in the virtual environment 400. The one or more computing systems can compute a spatial correspondence between the virtual renderings 418.1 through 418.n and three-dimensional virtual space coordinates of the virtual venue 414. The one or more computing systems can project, or texture-map, the virtual renderings 418.1 through 418.n onto these surfaces by applying homography transformations, rendering warping, and/or UV-mapping techniques, among others, that align the virtual renderings 418.1 through 418.n with the layout of the virtual venue 414. Virtual projection devices 416.1 through 416.n can be positioned within the virtual environment 400 to correspond to the virtual viewing points 404.1 through 404.n, projecting the three-dimensional coordinates of the virtual renderings 418.1 through 418.n onto the three-dimensional surfaces of the virtual venue 414. In some embodiments, the virtual projection devices 416.1 through 416.n can be implemented as virtual projectors that simulate physical projection devices to project the virtual renderings 418.1 through 418.n. The one or more computing systems can also compensate for surface curvature, uneven geometries, or occluded regions by applying non-linear warping functions or mesh-based projection models. Alternatively, or in addition, photometric corrections can be applied to account for ambient lighting conditions, ensuring that brightness, color, and contrast of the virtual content item 402 are consistent across the virtual venue 414. Through these mapping operations, the virtual renderings 418.1 through 418.n are seamlessly mapped onto the virtual venue 414, enabling the virtual content item 402 to be perceived as naturally integrated within the spatial and visual context of the virtual environment 400.

In the exemplary embodiment illustrated in FIG. 4E, the one or more computing systems can transform the virtual renderings 418.1 through 418.n from the virtual environment 200 into the real-world content items 104.1 through 104.n that are mapped onto the three-dimensional physical surfaces 110.1 through 110.n of the real-world venue 106 in the real-world environment 100. In these embodiments, the three-dimensional physical surfaces 110.1 through 110.n of the real-world venue 106 function as display surfaces for the real-world content items 104.1 through 104.n. For example, the real-world venue 106 can include a three-dimensional display structure configured as a curved, continuous display surface that envelops the real-world venue 106. In some embodiments, the one or more computing systems can adapt and/or align the real-world content items 104.1 through 104.n onto the three-dimensional physical surfaces 110.1 through 110.n. In these embodiments, the one or more computing systems can identify the coordinates, scales, and/or orientations of the virtual renderings 418.1 through 418.n that have been mapped onto the three-dimensional surfaces of the virtual venue 414 in the virtual environment 200. After identifying these parameters, the one or more computing systems can translate the coordinates, scales, and/or orientations of the virtual renderings 418.1 through 418.n from the virtual environment 200 into corresponding coordinates, scales, and/or orientations of the real-world content items 104.1 through 104.n in the real-world environment 100 to display the real-world content items 104.1 through 104.n on the three-dimensional physical surfaces 110.1 through 110.n. In some embodiments, the mapping can include computing a spatial correspondence between two-dimensional coordinates of the virtual renderings 418.1 through 418.n and three-dimensional coordinates of the three-dimensional physical surfaces 110.1 through 110.n. The one or more computing systems can apply homography transformations, rendering warping, or mesh-based mapping functions, among others, to the real-world content items 104.1 through 104.n to compensate for curvature, irregular geometries, or discontinuities across the three-dimensional physical surfaces 110.1 through 110.n. Additionally, the one or more computing systems can utilize plane detection algorithms to identify and segment the three-dimensional physical surfaces 110.1 through 110.n of the real-world venue 106 that are to display the real-world content items 104.1 through 104.n. Alternatively, or in addition, the one or more computing systems can apply photometric corrections to the real-world content items 104.1 through 104.n to account for brightness, contrast, shadows, and ambient lighting conditions within the real-world environment 100, ensuring that the real-world content items 104.1 through 104.n appear visually consistent across the three-dimensional physical surfaces 110.1 through 110.n. Through these transformation and mapping operations, the one or more computing systems seamlessly present the real-world content items 104.1 through 104.n on the three-dimensional physical surfaces 110.1 through 110.n of the real-world venue 106, such that the real-world content items 104.1 through 104.n is perceived as naturally integrated within the spatial and visual context of the real-world environment 100.

In some embodiments, the one or more computing systems can cause the real-world content items 104.1 through 104.n to be displayed on the real-world venue 106. In some embodiments, the one or more computing systems can provide rendering instructions, image streams, and/or projection control signals, among others, to one or more display devices associated with the real-world venue 106, such as projectors, LED panels, or other display apparatuses, to present the real-world content items 104.1 through 104.n onto the three-dimensional physical surfaces 110.1 through 110.n. In these embodiments, the one or more computing systems can synchronize the real-world content items 104.1 through 104.n across the three-dimensional physical surfaces 110.1 through 110.n to ensure temporal consistency and reduce visible artifacts such as flickering or tearing. In some embodiments, the one or more computing systems can dynamically adjust display parameters, such as brightness, color balance, or refresh rate, based on environmental conditions or sensor feedback from the real-world venue 106. In some embodiments, the one or more computing systems can cache or pre-load portions of the real-world content items 104.1 through 104.n to reduce latency and support seamless transitions during live events.

### Exemplary Operational Control Flow for the Exemplary Replication-Based Mapping

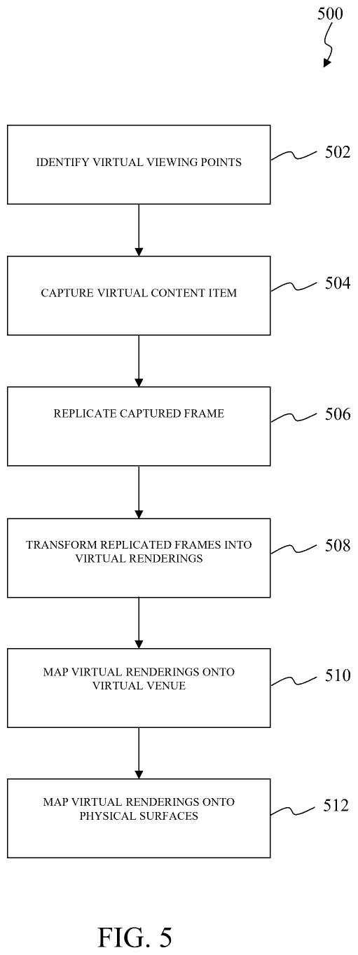

FIG. 5 illustrates an exemplary operational control flow for the exemplary replication-based mapping of exemplary real-world content items onto the exemplary real-world venue according to some exemplary embodiments of the present disclosure. The following discussion describes an exemplary operational control flow 500 for displaying one or more renderings of one or more real-world content items, such as the real-world content items 104.1 through 104.n to provide an example, from one or more real-world viewing points, such as the real-world viewing points 108.1 through 108.n to provide an example, onto a real-world venue, such as the real-world venue 106 to provide an example, in a real-world environment. The present disclosure is not limited to these exemplary operational control flows. Rather, it will be apparent to those skilled in the relevant art(s) that other operational control flows are within the scope and spirit of the present disclosure. In some embodiments, the operational control flow 500 can be performed by one or more computing systems, such as the content mapping server 102 described herein. Generally, the one or more computing systems can replicate a single instance of the real-world content items across three-dimensional physical surfaces of a real-world venue, such as the three-dimensional physical surfaces 110.1 through 110.n of the real-world venue 106 to provide an example, to create an immersive visual experience that can be beneficially observed from the real-world viewing points as described herein.

At operation 502, the operational control flow 500 identifies virtual viewing points, such as the virtual viewing points 404.1 through 404.n, within a virtual environment that correspond to the real-world viewing points in the real-world environment as described herein. In some embodiments, the virtual viewing points can be expressed as three-dimensional locations for observing one or more renderings of one or more virtual content items, such as the virtual content item 402, which have been mapped onto a virtual venue, such as the virtual venue 414 as described herein.

At operation 504, the operational control flow 500 captures the one or more virtual content item from operation 502 from a single virtual viewing point from among the virtual viewing points to provide a virtual capture frame, such as the virtual capture frame 408, as described herein. In some embodiments, the operational control flow 500 can instantiate a virtual capture device at the single virtual viewing point, parameterized to simulate a real-world camera's position, orientation, field of view, and lens characteristics as described herein.

At operation 506, the operational control flow 500 replicates the virtual capture frame from operation 504 to provide replicated captured frames, such as the replicated captured frames 412.1 through 412.n, as described herein. Each replicated captured frame corresponds to a distinct surface region of the virtual venue as described herein. In some embodiments, the operational control flow 500 can apply preliminary photometric or geometric corrections to ensure seamless integration across the surfaces as described herein.

At operation 508, the operational control flow 500 transforms the replicated captured frames from operation 506 from two-dimensional image space coordinates onto three-dimensional virtual space coordinates of the virtual venue to generate virtual renderings, such as the virtual renderings 418.1 through 418.n, as described herein. In some embodiments, this transformation can include mapping from pixel coordinates to normalized UV coordinates, then to spherical coordinates, and finally to three-dimensional Cartesian coordinates, ensuring correct placement and visual consistency as described herein.

At operation 510, the operational control flow 500 maps the virtual renderings from operation 508 onto the virtual venue in the virtual environment as described herein. This can include computing spatial correspondences, applying homography transformations, warping functions, and/or UV-mapping techniques, among others, as described herein. In some embodiments, the operational control flow 500 can position virtual projection devices to simulate real-world projection onto the virtual venue as described herein. In some embodiments, the operational control flow 500 can apply photometric corrections to ensure uniform brightness, contrast, and/or color, among others, across the three-dimensional physical surfaces of the real-world venue as described herein.

At operation 512, the operational control flow 500 transforms the virtual renderings from operation 508 to provide the one or more real-world content items for mapping onto three-dimensional physical surfaces of the real-world venue, such as the three-dimensional physical surfaces 110.1 through 110.n of the real-world venue 106, in the real-world environment as described herein. The operational control flow 500 can adapt and/or align the coordinates, scales, and orientations of the virtual renderings to the three-dimensional physical surfaces, compensating for curvature, scale, and lighting conditions to provide the real-world renderings as described herein. In these embodiments, the operational control flow 500 can apply plane detection, mesh-based mapping, and/or photometric correction algorithms, among others, to ensure real-world renderings appear consistent and integrated across the physical surfaces, allowing the one or more real-world content items to be perceived as naturally integrated within the spatial and visual context of the real-world environment as described herein.

Exemplary Region-Based Mapping of Exemplary Real-World Content Items onto the Exemplary Real-World Structure

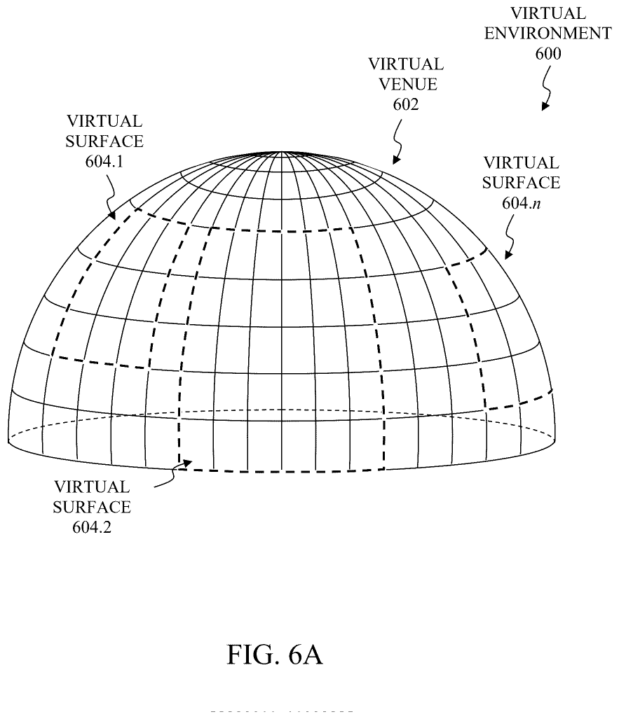

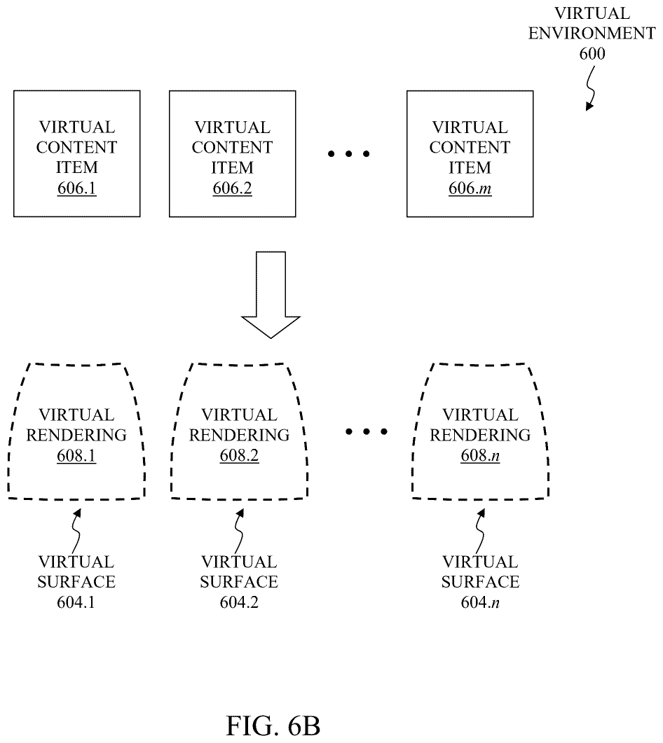

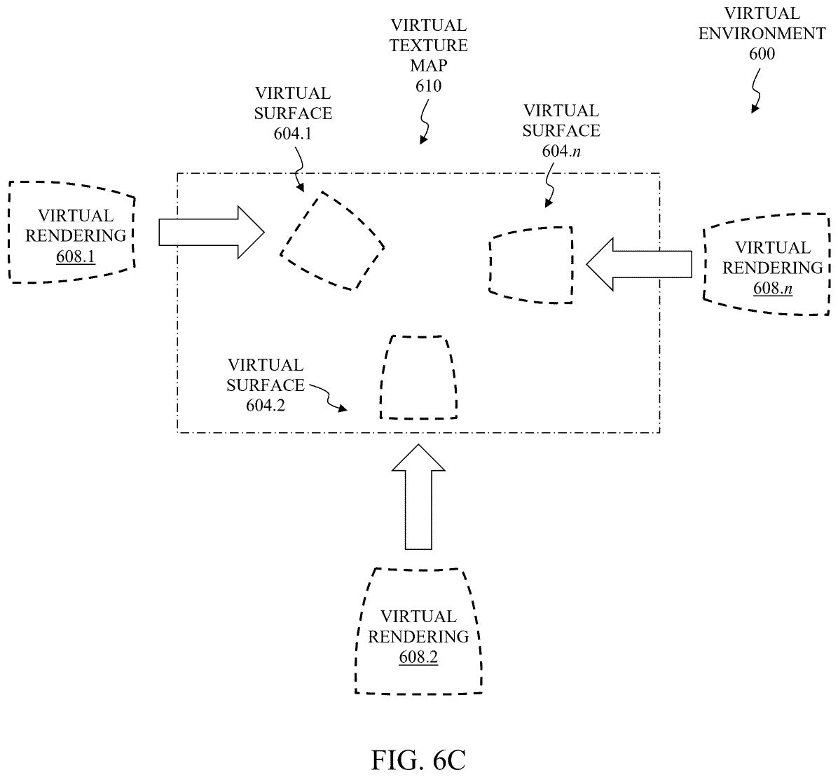

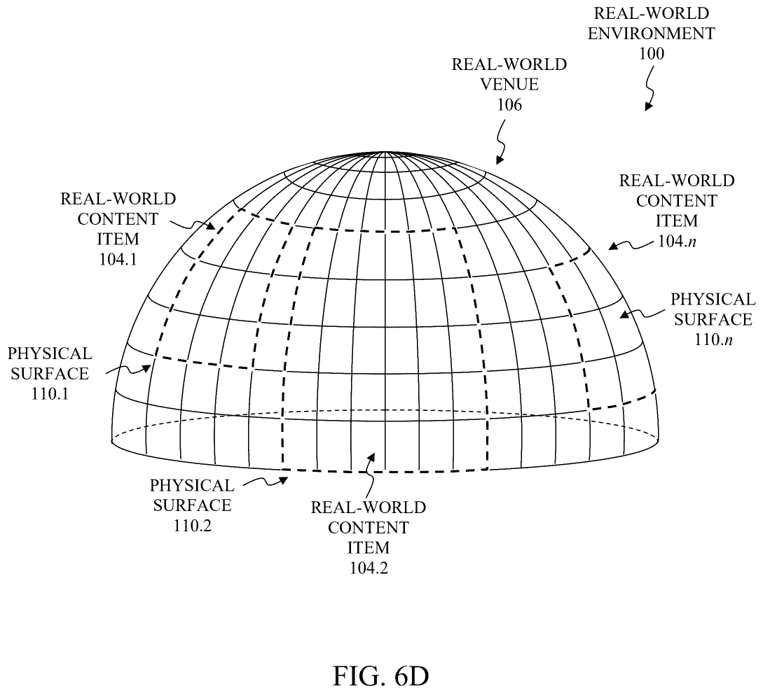

FIG. 6A through FIG. 6D graphically illustrate exemplary region-based mapping of exemplary real-world content items onto the exemplary real-world structure according to some exemplary embodiments of the present disclosure. In the exemplary embodiments illustrated in FIG. 6A through FIG. 6D, one or more computing systems, such as the content mapping server 102 described herein, can incorporate a region-based mapping to strategically divide the real-world venue 106 into the three-dimensional physical surfaces 110.1 through 110.n and map the real-world content items 104.1 through 104.n onto the three-dimensional physical surfaces 110.1 through 110.n. Generally, the one or more computing systems, an exemplary embodiment of which is to be described in further detail below, can incorporate the region-based mapping to map the real-world content items 104.1 through 104.n onto the real-world venue 106 to create an immersive visual experience that can be beneficially observed from the real-world viewing points 108.1 through 108.n as described herein.

As illustrated in FIG. 6A, the one or more computing systems can identify virtual surfaces 604.1 through 604.n of a virtual venue 602 within the virtual environment 600 that correspond to the three-dimensional physical surfaces 110.1 through 110.n within the real-world environment 100. In some embodiments, the one or more computing systems can access a virtual representation of the real-world venue 106 in the virtual environment 600 to provide the virtual venue 602. In some embodiments, the virtual venue 602 can be characterized as being a computer-generated model of the real-world venue 106 in the virtual environment 600. In these embodiments, the one or more computing systems can model the real-world venue 106 in the virtual environment 600 to develop the virtual venue 602. In some embodiments, the one or more computing systems can estimate the three-dimensional physical surfaces 110.1 through 110.n of the real-world venue 106 within the real-world environment 100 to develop corresponding three-dimensional surfaces for the virtual venue 602 in terms of three-dimensional shapes, for example, cubes, spheres, and/or cylinders, among others, in the virtual environment 600. In these embodiments, the one or more computing systems can further develop these corresponding three-dimensional surfaces for the virtual venue 602 to include, for example, coloring, texture mapping, shading, and/or lighting, among others, to provide some examples. In some embodiments, the one or more computing systems can place the virtual venue 602 within the virtual environment 600 as illustrated in FIG. 6A. In these embodiments, the one or more computing systems can position, for example, move, rotate, and/or scale, among others, the virtual venue 602 within the virtual environment 600. Alternatively, or in addition to, the one or more computing systems can apply coloring, texture mapping, shading, and/or lighting, among others, to provide some examples to the virtual venue 602 within the virtual environment 600. In some embodiments, the one or more computing systems can execute any suitable game engine, for example, Unity, Unreal Engine, and/or Godot, among others, that will be apparent to those skilled in the relevant art(s) to develop the virtual venue 602 as described herein without departing from the spirit and scope of the present disclosure.

In some embodiments, the virtual surfaces 604.1 through 604.n can be predefined, for example, based on a stored template or model of the real-world venue 106. Alternatively, or in addition to, the virtual surfaces 604.1 through 604.n can be dynamically adjusted in real time, for example, responsive to sensor input, camera feeds, user interactions, and/or manual and/or artistic techniques applied by a designer or operator within the virtual environment 600, among others. In these embodiments, the one or more computing systems can refine the size, orientation, geometry, and/or aesthetic presentation, among others, of the virtual surfaces 604.1 through 604.n to better align with or creatively reinterpret the three-dimensional physical surfaces 110.1 through 110.n in the real-world environment 100. In some embodiments, the one or more computing systems can incorporate the suitable game engine described herein to perform these adjustments. In these embodiments, the suitable game engine described herein can adjust mesh geometry of the virtual surfaces using vertex manipulation, subdivision, and/or Boolean operations, among others, and can further adjust surface placement and scaling by updating transformation matrices in real time, or near-real time. Alternatively, or in addition to, the suitable game engine described herein can modify texture coordinates, for example, UV mapping, and/or shader parameters, among others, to refine alignment of the real-world content items 104.1 through 104.n and/or to apply stylized artistic effects, among others. In some embodiments, the suitable game engine described herein can receive data streams from external sensors or cameras as input and update the virtual surfaces using runtime scripting. Alternatively, or in addition to, a designer or operator can manually adjust the virtual surfaces using in-engine editing tools, such as drag-and-drop positioning, sculpting brushes, and/or texture-painting interfaces, among others. Alternatively, or in addition to, the adjustments can be procedurally generated, for example, by applying shader-based deformation, physics simulation, or rule-based algorithms executed by the suitable game engine. In some embodiments, the virtual surfaces 604.1 through 604.n can be generated using a hybrid approach that combines both predefined and dynamic techniques. In these embodiments, the virtual surfaces 604.1 through 604.n can be initially based on a stored template or model of the real-world venue 106 and then refined or updated in real time responsive to sensor input, camera feeds, user interactions, and/or manual or artistic adjustments. In these embodiments, the predefined model can provide a baseline structure for the virtual venue 602, while the dynamic updates ensure accurate alignment with the corresponding three-dimensional physical surfaces 110.1 through 110.n or allow for creative reinterpretation within the virtual environment 600.

In the exemplary embodiment illustrated in FIG. 6B, the one or more computing systems can access the one or more virtual content items 606.1 through 606.m. In some embodiments, the one or more virtual content items 606.1 through 606.m can represent, or be derived from one or more of the source content items described herein. As illustrated in FIG. 6B, the one or more computing systems can transform one or more virtual content items 606.1 through 606.m to generate virtual renderings 608.1 through 608.n in the virtual environment 600. Generally, the one or more computing systems can apply one-to-one, one-to-many, many-to-one, and/or many-to-many transformation mappings, among others, between the virtual content items 606.1 through 606.m and the virtual renderings 608.1 through 608.n without departing from the spirit and scope of the present disclosure. In some embodiments, the one or more virtual content items 606.1 through 606.m can include a single virtual content items 606.1 or multiple virtual content items 606.1 through 606.m depending on, for example, the configuration of the virtual environment 600 and/or the desired rendering outcome, among others. In some embodiments, the one or more computing systems can transform a single virtual content item from among the one or more virtual content items 606.1 through 606.m to generate a corresponding virtual rendering from among the generate virtual renderings 608.1 through 608.n. Alternatively, or in addition to, the one or more computing systems can transform the single virtual content item to generate multiple virtual renderings from among the generate virtual renderings 608.1 through 608.n. In some embodiments, the one or more computing systems can transform multiple virtual content items from among the one or more virtual content items 606.1 through 606.m to generate multiple virtual renderings from among the generate virtual renderings 608.1 through 608.n.

In some embodiments, these transformations ensure that the one or more virtual content items 606.1 through 606.m is accurately and consistently represented when displayed in the virtual environment 600. Without these transformations, geometric distortions, misaligned depth, or incorrect occlusions could occur due to the spatial configuration of the real-world venue 106, which can lead to a degraded or confusing viewing experience. Additionally, photometric differences such as variations in color, brightness, and contrast could cause the one or more virtual content items 606.1 through 606.m to appear unnatural or inconsistent across the virtual surfaces 604.1 through 604.n. By applying geometric, photometric, and/or viewer-specific adjustments, among others, the one or more computing systems ensure that the virtual surfaces 604.1 through 604.n perceive coherent, immersive, and visually accurate renderings of the one or more virtual content items 606.1 through 606.m, regardless of their location or angle of view, thereby preserving both the aesthetic quality and the immersive experience intended for the one or more virtual content items 606.1 through 606.m.

In some embodiments, the one or more computing systems can transform the one or more virtual content items 606.1 through 606.m from two-dimensional image space coordinates onto the virtual surfaces 604.1 through 604.n. In these embodiments, the one or more computing systems can implement a multi-step transformation process to transform the one or more virtual content items 606.1 through 606.m from the two-dimensional image space coordinates onto the virtual surfaces 604.1 through 604.n. In some embodiments, the one or more virtual content items 606.1 through 606.m can be expressed in two-dimensional image space coordinates, for example, pixel coordinates (x, y) in a Cartesian coordinate system. In some embodiments, the one or more computing systems can map the one or more virtual content items 606.1 through 606.m from the pixel coordinates (x, y) onto normalized UV coordinates of a UV coordinate system, which ranges from 0 to 1, that corresponds to the three-dimensional geometry of the virtual surfaces 604.1 through 604.n. In these embodiments, this normalizing of the pixel coordinates (x, y) converts resolution-dependent pixel positions into a universal, geometry-friendly UV coordinate system that can then be mapped onto the virtual surfaces 604.1 through 604.n. Generally, the one or more computing systems can map the one or more virtual content items 606.1 through 606.m from the pixel coordinates (x, y) into the normalized UV coordinates according to:

$$U = \frac{x}{W - 1} , and \qquad ( 19 )$$

$$V = \frac{y}{H - 1} , \qquad ( 20 )$$

wherein W and H represent the width and the height, respectively, of the one or more virtual content items 606.1 through 606.m.

In some embodiments, the one or more computing systems can remap the one or more virtual content items 606.1 through 606.m from the normalized UV coordinates into spherical coordinates (θ, φ) of a spherical coordinate system. In these embodiments, the one or more computing systems can remap the one or more virtual content items 606.1 through 606.m from the normalized UV coordinates onto the spherical coordinates (θ, φ) using a spherical transform (ST) map. In these embodiments, this remapping generates “warped” representations of the one or more virtual content items 606.1 through 606.m, which may appear stretched or compressed in two dimensions, to ensure that the one or more virtual content items 606.1 through 606.m align and display correctly on the virtual surfaces 604.1 through 604.n. Generally, the one or more computing systems can map the one or more virtual content items 606.1 through 606.m from the normalized UV coordinates onto the spherical coordinates (θ, φ) according to:

$$θ = 2 π u , and \qquad ( 21 )$$

$$φ = π v , \qquad ( 22 )$$

wherein the longitude θ refers to a circumference around the virtual venue 602 and the latitude φ refers to a height of the virtual venue 602.

In some embodiments, the one or more computing systems can remap the one or more virtual content items 606.1 through 606.m from the spherical coordinates (θ, φ) to three-dimensional coordinates (x′, y′, z′) of the Cartesian coordinate system to generate the virtual renderings 608.1 through 608.n. Generally, the one or more computing systems can map the one or more virtual content items 606.1 through 606.m from the spherical coordinates (θ, φ) to the three-dimensional coordinates (x′, y′, z′) according to:

$${x}^{′} = sin φ cos θ , \qquad ( 23 )$$

$${y}^{′} = sin φ sin θ , \qquad ( 24 )$$

$${z}^{′} = cos φ . \qquad ( 25 )$$

In some embodiments, through this sequence of mappings, from pixel space to normalized UV space, to spherical coordinates, and finally to Cartesian coordinates, the one or more computing systems can accurately place the one or more virtual content items 606.1 through 606.m onto the virtual surfaces 604.1 through 604.n. In some embodiments, the one or more computing systems can implement the mapping transformations of the virtual content items 606.1 through 606.m, from pixel coordinates to normalized UV coordinates, to spherical coordinates, and finally to three-dimensional Cartesian coordinates, within the suitable game engine. In these embodiments, the transformations can be executed using engine-provided projection utilities, runtime scripts, compute kernels, and/or shader programs, among others. By performing the transformations within the suitable game engine, the one or more computing systems can leverage the suitable engine's real-time rendering pipeline, optimize performance, and ensure accurate placement, alignment, and visual consistency of the virtual content items 606.1 through 606.m on the virtual surfaces 604.1 through 604.n.

As illustrated in FIG. 6C, the one or more computing systems can map the virtual renderings 608.1 through 608.n onto the virtual surfaces 604.1 through 604.n in the virtual environment 600. In some embodiments, the one or more computing systems can map the virtual renderings 608.1 through 608.n onto a two-dimensional representation of the virtual venue 602 in the virtual environment 600. In these embodiments, the two-dimensional representation of the virtual venue 602 can represent an equirectangular representation of the virtual venue 602 as illustrated in FIG. 6C. However, those skilled in the relevant art(s) will recognize that other two-dimensional representations of the virtual venue 602 are possible, for example, spherical, cylindrical, Mercator, azimuthal, cube map, octahedral, and/or parametric projection, among others, without departing from the spirit and scope of the present disclosure. In some embodiments, the two-dimensional representation of the virtual venue 602 can include the virtual surfaces 604.1 through 604.n. In these embodiments, the one or more computing systems can generate the two-dimensional representation by projecting the three-dimensional geometry of the virtual surfaces 604.1 through 604.n into a two-dimensional coordinate space of the two-dimensional representation. For example, the one or more computing systems can assign each point of the virtual surfaces 604.1 through 604.n to corresponding pairs of coordinates (u,v) in the two-dimensional representation based on its position in a latitude-longitude, spherical, cylindrical, or other selected mapping function. In some embodiments, edges between adjacent virtual surfaces can be preserved or stitched to maintain continuity in the two-dimensional representation, thereby allowing the virtual renderings 608.1 through 608.n to be stored, transmitted, or rendered as a virtual texture map 610 of the virtual venue 602.

As illustrated in FIG. 6C, the one or more computing systems can map the virtual renderings 608.1 through 608.n onto the virtual surfaces 604.1 through 604.n to generate the virtual texture map 610. In some embodiments, the one or more computing systems can combine the virtual renderings 608.1 through 608.n by projecting the virtual renderings 608.1 through 608.n onto corresponding virtual surfaces from among the virtual surfaces 604.1 through 604.n that have been projected onto the two-dimensional representation of the virtual venue 602. In these embodiments, the virtual renderings 608.1 through 608.n can be mapped to corresponding two-dimensional coordinates of their corresponding virtual surfaces. In some embodiments, the one or more computing systems can perform geometric transformations, such as scaling, rotation, and/or skewing, among others, on the virtual renderings 608.1 through 608.n to ensure proper alignment of the virtual renderings 608.1 through 608.n among the virtual surfaces 604.1 through 604.n within the two-dimensional representation. In some embodiments, the one or more computing systems can implement the mapping and combination of virtual renderings 608.1 through 608.n onto the virtual surfaces 604.1 through 604.n within the suitable game engine described herein. In these embodiments, the suitable game engine described herein can perform the geometric transformations, including scaling, rotation, and skewing, by updating transformation matrices of the virtual renderings 608.1 through 608.n relative to the virtual surfaces 604.1 through 604.n. In these embodiments, the suitable game engine described herein can further assign each virtual rendering 608.1 through 608.n to texture coordinates of its corresponding virtual surface using UV mapping, and optionally perform texture atlas generation to combine multiple virtual renderings into the virtual texture map 610. In some embodiments, the suitable game engine described herein can execute runtime scripts or compute kernels to adjust alignment and blending in real time, and can employ shader programs to perform per-pixel transformations, color correction, and edge blending. Additionally, the suitable game engine described herein can apply interpolation, anti-aliasing, and filtering operations to ensure smooth transitions across adjacent virtual surfaces 604.1 through 604.n and maintain high visual fidelity for subsequent rendering in the virtual environment 600.

In the exemplary embodiment illustrated in FIG. 6C, the one or more computing systems can optionally perform stitching and blending across adjacent virtual surfaces 604.1 through 604.n to improve continuity and/or visual coherence across the virtual surfaces 604.1 through 604.n. By performing this stitching and blending, the one or more computing systems ensure the virtual texture map 610 provides a continuous, seamless, and visually coherent representation of the virtual venue 602. In some embodiments, one or more computing systems can stitch together adjacent virtual surfaces from among the virtual surfaces 604.1 through 604.n in the two-dimensional representation by identifying boundary regions and blending pixel values at these boundaries using techniques such as per-region falloff, gradient masks, feathering, alpha blending, and/or rotoshape-based compositing, among others. Alternatively, or in addition to, the one or more computing systems can perform multi-input blending, combining overlapping virtual renderings 608.1 through 608.n across neighboring surfaces using procedural blending, shader-based techniques, texture splatting, and/or compositing layers, among others. Alternatively, or in addition to, the one or more computing systems can perform photometric adjustments, such as color correction, brightness, and/or contrast normalization, among others, across the virtual texture map 610 to ensure a uniform visual appearance. Alternatively, or in addition to, the one or more computing systems can adjust alignment, scaling, rotation, and/or cropping, among others, of the virtual renderings 608.1 through 608.n and can overlay gradients, patterns, or textures onto discontinuities to compensate for gaps, misalignments, or separations between adjacent virtual renderings from among the virtual renderings 608.1 through 608.n.

In some embodiments, the one or more computing systems can store the virtual texture map 610 as a file in one or more standard formats suitable for graphics processing and game engine usage. In these embodiments, the one or more computing systems can store the virtual texture map 610 as a raster image file, such as Portable Network Graphics (PNG), Joint Photographic Experts Group (JPEG), Tagged Image File Format (TIFF), or Bitmap Image File (BMP), or as a graphics or game engine-specific file, such as Targa (TGA), DirectDraw Surface (DDS), or OpenEXR (EXR). Alternatively, or in addition to, the one or more computing systems can store the virtual texture map 610 in graphics processing unit (GPU)-optimized formats, including Khronos Texture (KTX), Adaptive Scalable Texture Compression (ASTC), or Block Compression (BCn), among others.

In the exemplary embodiment illustrated in FIG. 6D, the one or more computing systems can cause the real-world venue 106 to display the virtual texture map 610 as the real-world content items 104.1 through 104.n on the three-dimensional physical surfaces 110.1 through 110.n. In some embodiments, the one or more computing systems can provide rendering instructions, image streams, and/or projection control signals to one or more display devices associated with the real-world venue 106, such as projectors, light-emitting diode (LED) panels, or other suitable display apparatuses, to present the virtual texture map 610 on the physical surfaces 110.1 through 110.n. In these embodiments, the one or more computing systems can synchronize the real-world content items 104.1 through 104.n across the physical surfaces 110.1 through 110.n to ensure temporal consistency and reduce visible artifacts, including flickering, tearing, or misalignment. Alternatively, or in addition to, the one or more computing systems can also dynamically adjust display parameters, such as brightness, color balance, contrast, or refresh rate, based on environmental conditions or sensor feedback from the real-world venue 106. Additionally, the one or more computing systems can cache or pre-load portions of the virtual texture map 610 to reduce latency and support seamless transitions during live or dynamic events. By performing these operations, the one or more computing systems ensure that the virtual texture map 610, when displayed on the real-world surfaces 110.1 through 110.n, provides an immersive, temporally coherent, and visually continuous experience for observers within the real-world venue 106.

### Exemplary Operational Control Flow for the Exemplary Region-Based Mapping

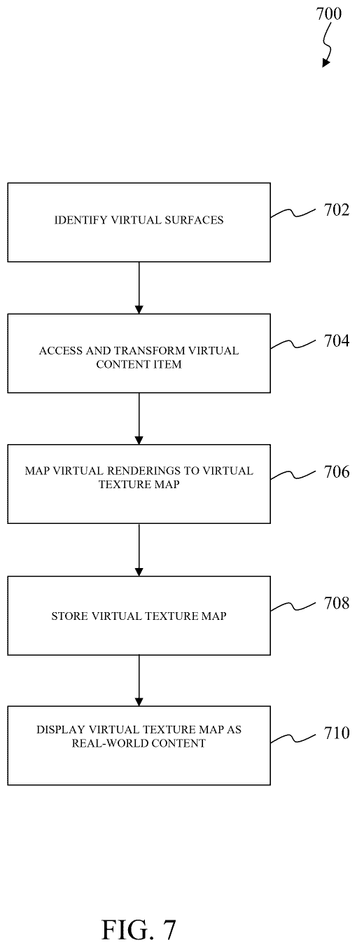

FIG. 7 illustrates an exemplary operational control flow for region-based mapping of exemplary real-world content items onto an exemplary real-world venue according to some exemplary embodiments of the present disclosure. The following discussion describes an exemplary operational control flow 700 for displaying one or more renderings of one or more real-world content items, such as the real-world content items 104.1 through 104.n to provide an example, from one or more real-world viewing points, such as the real-world viewing points 108.1 through 108.n to provide an example, onto a real-world venue, such as the real-world venue 106 to provide an example, in a real-world environment. The present disclosure is not limited to these exemplary operational control flows. Rather, it will be apparent to those skilled in the relevant art(s) that other operational control flows are within the scope and spirit of the present disclosure. In some embodiments, the operational control flow 700 can be performed by one or more computing systems, such as the content mapping server 102 described herein. Generally, the one or more computing systems can strategically divide a real-world venue, such as the real-world venue 106 to provide an example, into three-dimensional physical surfaces, such as the three-dimensional physical surfaces 110.1 through 110.n to provide, and map the one or more real-world content items onto the three-dimensional physical surfaces to create a consistent, immersive, and perspective-correct visual experience across the real-world venue.

At operation 702, the operational control flow 700 identifies virtual surfaces of a virtual venue, such as the virtual surfaces 604.1 through 604.n of the virtual venue 602 to provide an example, which correspond to the three-dimensional physical surfaces as described herein. The virtual surfaces can be predefined from stored models or dynamically adjusted in real time based on sensor input, user interactions, or manual/creative adjustments as described herein.

At operation 704, the operational control flow 700 accesses one or more virtual content items, such as the virtual content items 606.1 through 606.m to provide an example, and transforms the one or more virtual content items to generate virtual renderings, such as the virtual renderings 608.1 through 608.n to provide an example, as described herein. Transformations can include mapping from 2D pixel coordinates to normalized UV coordinates, then to spherical coordinates, and finally to three-dimensional Cartesian coordinates, ensuring correct geometric and photometric alignment on the virtual surfaces from operation 702 as described herein.

At operation 706, the operational control flow 700 maps virtual renderings from operation 704 onto the virtual surfaces from 702 to generate a virtual texture map, such as the virtual texture map 610 to provide an example, as described herein. This can include geometric transformations, UV mapping, blending, edge correction, and photometric adjustments to ensure a continuous and visually coherent texture representation of the virtual venue from operation 702 as described herein.

At operation 708, the operational control flow 700 stores the virtual texture map from operation 706 as a file in one or more standard or GPU-optimized formats (e.g., PNG, JPEG, EXR, ASTC) as described herein.

At operation 710, the operational control flow 700 causes the real-world venue to display the virtual texture map from operation 706 as the one or more real-world content items on the three-dimensional physical surfaces as described herein. The operational control flow 700 can provide rendering instructions, image streams, and/or projection control signals to display devices such as projectors or LED panels as described herein. Temporal synchronization, dynamic display parameter adjustment, for example, brightness, contrast, and/or color balance, among others, and photometric alignment ensure immersive, visually continuous, and temporally coherent content items for observers as described herein.

Exemplary Computer System that can be Implemented within the Exemplary Real-World Environment

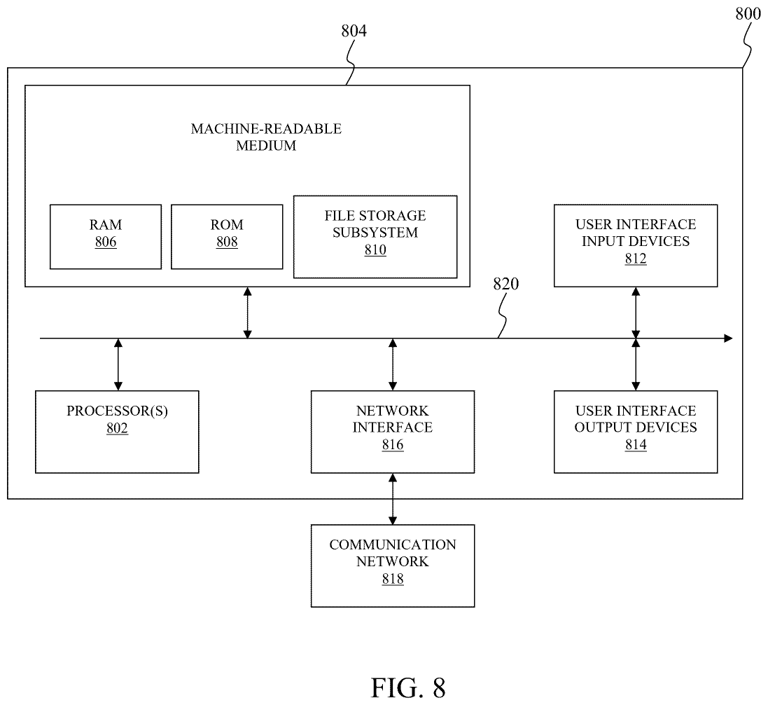

FIG. 8 graphically illustrates a simplified block diagram of a computing device that can incorporated within the exemplary real-world environment according to some embodiments of the present disclosure. The discussion of FIG. 8 to follow is intended to describe a representative computing device 800 that can be configured and programmed to implement, for example, the content mapping server 102.

In the embodiment illustrated in FIG. 8, the computing device 800 includes one or more processors 802. In some embodiments, the one or more processors 802 can include, or can be, any of a microprocessor, graphics processing unit (GPU), or digital signal processor (DSP), as well as their functional or structural equivalents, such as, without limitation, an Application Specific Integrated Circuit (ASIC), a Field Programmable Gate Array (FPGA), a system-on-chip (SoC), or a neural processing unit (NPU). These processors may be selected based on performance requirements for real-time audio signal processing, waveform synthesis, digital filtering, or machine-learning inference used in interactive control environments. As used herein, the term “processor” signifies a tangible computing component or arrangement that performs data and signal processing operations by transforming input signals into output signals using a defined set of instructions or logic. The transformation may involve arithmetic operations, logical comparisons, memory accesses, and/or parallel data streaming. The data and information acted upon can be in physical form by signals such as, without limitation, voltages, currents, magnetic fields, optical pulses, or acoustic vibrations, which are capable of being sensed, measured, stored, transferred, and manipulated. The term “processor” may also refer to a single-core or multi-core processor, a distributed array of processor cores, or a multi-chip processing module. These can include general-purpose CPUs, specialized co-processors for multimedia acceleration, and digital audio engines integrated into system-on-chip platforms. In some implementations, the one or more processors 802 may execute software or firmware components that support features such as, without limitation, real-time processing, simulation, data transformation, or analysis of signals or information. Additionally, the one or more processors 802 may execute within a distributed computing environment, such as, without limitation, a virtualized infrastructure, a cloud computing platform, or a containerized environment running a software-as-a-service (SaaS) instance. For example, operations of the computing device 800 may be offloaded in whole or in part to remote compute nodes accessible via an application programming interface (API) over a network connection. This allows processing of high-complexity control signals and real-time response synchronization to be executed in scalable or latency-optimized environments.

In some embodiments, the computing device 800 can operate under a host operating system, which can include Microsoft Windows, MacOS by Apple, Linux distributions such as, without limitation, Ubuntu or Red Hat, UNIX variants, or real-time operating systems (RTOS). The computing device 800 may also include a Basic Input/Output System (BIOS), Unified Extensible Firmware Interface (UEFI), or similar low-level system firmware used to initialize and control hardware subsystems.

As illustrated in FIG. 8, the computing device 800 further includes a machine-readable medium 804, which may comprise one or more forms of tangible, non-transitory storage elements accessible by the one or more processors 802. In some embodiments, the machine-readable medium 804 includes a main random-access memory (RAM) 806, a read-only memory (ROM) 808, and/or a file storage subsystem 810. The RAM 806 can include volatile memory such as, without limitation, static RAM (SRAM) or dynamic RAM (DRAM), which is used for storing temporary instruction sets and runtime data for execution. ROM 808 can include firmware-stored initialization code or bootloaders and is typically implemented using non-volatile technologies such as, without limitation, EEPROM, flash memory, or mask ROM. The file storage subsystem 810 provides persistent storage for system software, user data, control signal templates, and audio simulation parameters. It can include one or more mass storage devices such as, without limitation, solid-state drives (SSD), hard disk drives (HDD), optical drives, removable media such as, without limitation, flash drives or secure digital (SD) cards, and/or network-attached storage. The file storage subsystem 810 may support hierarchical file systems and may be accessible via high-speed internal interfaces such as, without limitation, Serial Advanced Technology Attachment (SATA), Peripheral Component Interconnect Express (PCIe), and/or Non-Volatile Memory Express (NVMe), or external interfaces such as, without limitation, Universal Serial Bus (USB) or Thunderbolt, among others

The computing device 800 may also include one or more user interface input devices 812 and user interface output devices 814 for interaction with the user or operator. The user interface input devices 812 can include tactile, gesture-based, or biometric mechanisms such as, without limitation, an alphanumeric keyboard, touchscreen, capacitive touchpad, trackball, stylus, voice command system, microphone array, gesture camera, brain-computer interface, and/or electromyographic sensor, among others In some implementations, the computing device 800 can support multi-modal input techniques to allow simultaneous use of voice, gesture, or other input methods for controlling or interacting with system functions. These input devices 812 may be connected using wired interfaces such as, without limitation, USB, serial, and/or Inter-Integrated Circuit (I2C) or wireless protocols such as, without limitation, Bluetooth, Wi-Fi, or 4G. In some embodiments, these interfaces can allow interfaces may allow low-latency control over various parameters using real-time interactive input. The user interface output devices 814 can include visual, auditory, and/or haptic feedback mechanisms. Visual output may be provided by high-resolution displays such as, without limitation, Liquid Crystal Display (LCD), Organic Light-Emitting Diode (OLED), and/or Electronic Ink, among others, projection systems, or head-mounted displays (HMDs) for augmented or virtual reality environments. Audio output devices can include internal speakers, external sound systems, or specialized transducers such as, without limitation, ultrasonic emitters or bone-conduction devices. Haptic feedback may be delivered through vibration actuators or force-feedback mechanisms. These outputs may be used to convey feedback during waveform preview, device synchronization, or simulation of dynamic audio environments.

The computing device 800 may also include a network interface 816 to facilitate bidirectional communication with external systems and networks, including interface with a communication network 818. The network interface 816 may support various networking protocols and physical interfaces such as, without limitation, Universal Serial Bus (USB), Recommended Standard 232 (RS-232), RS-484, Universal Asynchronous Receiver-Transmitter (UART), Thunderbolt, Peripheral Component Interconnect Express (PCIe) Fire Wire (IEEE 1394), Ethernet (IEEE 802.3), Ethernet for Control Automation Technology, Ethernet for Control Automation Technology (EtherCAT), HDBaseT, Serial ATA (SATA), Small Computer System Interface (SCSI), Inter-Integrated Circuit (I2C), Serial Peripheral Interface (SPI), Bluetooth, Near Field Communication (NFC), Infrared, Wi-Fi (IEEE 802.11), Ultra-Wideband (UWB), Millimeter Wave Communication (mmWave), Light Fidelity (Li-Fi), Fifth Generation Mobile Networks (4G), Long-Term Evolution (4G LTE), Zigbee, and/or Z-Wave, among others, to provide some examples. The network interface 816 may enable the computing device 800 to communicate with distributed audio control systems, cloud-based waveform libraries, remote signal processors, or external event systems such as, without limitation, performance automation frameworks. The communication network 818 can include a local area network (LAN), a wide area network (WAN), a mesh network, or a hybrid architecture. Security protocols such as, without limitation, Transport Layer Security (TLS), Secure Sockets Layer (SSL), or IPsec may be used to ensure data integrity and confidentiality. Virtual private network (VPN) tunnels and firewall rules may be implemented for secure communication with remote systems. Communication interfaces may utilize protocols such as, without limitation, Transmission Control Protocol/Internet Protocol (TCP/IP), User Datagram Protocol (UDP), HyperText Transfer Protocol/HyperText Transfer Protocol Secure (HTTP/S), Message Queuing Telemetry Transport (MQTT), WebSocket, and/or custom application-specific protocols for data transfer, among others.

As illustrated in FIG. 8, the various components of the computing device 800, including, for example, the one or more processors 802, machine-readable medium 804, user interface input devices 812, user interface output devices 814, and network interface 816 are communicatively interconnected via a bus subsystem 820. The bus subsystem 820 can include one or more high-speed system buses, peripheral buses such as, without limitation, PCIe, memory buses, or internal chip interconnects. In some configurations, Direct Memory Access (DMA) channels may be used to facilitate high-throughput data transfer between memory and I/O subsystems without processor intervention, enabling lower latency and more efficient real-time audio processing. While shown as a unified bus for simplicity, the bus subsystem 820 can include multiple hierarchical or crossbar switch-based interconnects optimized for specific data paths, such as, without limitation, audio stream buffering, graphical rendering, or external signal routing.

### CONCLUSION

The Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The Detailed Description is not meant to be limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes and are not intended to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A method for mapping a real-world content item onto a real-world venue, the method comprising:
identifying, by one or more computing systems, a plurality of three-dimensional virtual surfaces of a virtual venue corresponding to a plurality of three-dimensional physical surfaces of the real-world venue;
accessing, by the one or more computing systems, a virtual content item;
transforming, by the one or more computing systems, the virtual content item to generate one or more virtual renderings for the plurality of three-dimensional virtual surfaces;
mapping, by the one or more computing systems, the one or more virtual renderings onto the plurality of three-dimensional virtual surfaces to generate a virtual texture map; and
causing, by the one or more computing systems, the real-world venue to display the virtual texture map as the real-world content item on the plurality of three-dimensional physical surfaces.

2. The method of claim 1, wherein the virtual content item comprises one or more images, videos, textures, or three-dimensional models.

3. The method of claim 1, wherein the transforming comprises computing a spatial correspondence between the plurality of virtual renderings and the plurality of three-dimensional virtual surfaces of the virtual venue.

4. The method of claim 3, wherein the computing the spatial correspondence comprises:
mapping the virtual content item from two-dimensional pixel coordinates to normalized UV coordinates;
remapping the normalized UV coordinates to spherical coordinates using a spherical transform (ST) map; and
converting the spherical coordinates to three-dimensional Cartesian coordinates corresponding to the plurality of three-dimensional virtual surfaces of the virtual venue.

5. The method of claim 1, wherein the mapping comprises projecting the one or more virtual renderings onto a two-dimensional representation of the virtual venue having the plurality of three-dimensional virtual surfaces to generate the virtual texture map.

6. The method of claim 5, wherein the two-dimensional representation comprises an equirectangular projection of the virtual venue.

7. The method of claim 1, wherein the mapping comprises stitching and blending adjacent virtual renderings from among the plurality of adjacent virtual renderings to generate a visually continuous and seamless representation of the virtual content item.

8. A content mapping server for mapping a real-world content item onto a real-world venue, the content mapping server comprising:
a memory configured to store a virtual venue representing the real-world venue; and
a processor, configured to execute instructions stored in the memory, the instructions, when executed by the processor, configuring the processor to:
identify a plurality of three-dimensional virtual surfaces of the virtual venue corresponding to a plurality of three-dimensional physical surfaces of the real-world venue;
access a virtual content item;
transform the virtual content item to generate one or more virtual renderings for the plurality of three-dimensional virtual surfaces;
map the one or more virtual renderings onto the plurality of three-dimensional virtual surfaces to generate a virtual texture map; and
cause the real-world venue to display the virtual texture map as the real-world content item on the plurality of three-dimensional physical surfaces.

9. The content mapping server of claim 8, wherein the virtual content item comprises one or more images, videos, textures, or three-dimensional models.

10. The content mapping server of claim 8, wherein the instructions, when executed by the processor, configure the processor to compute a spatial correspondence between the plurality of virtual renderings and the plurality of three-dimensional virtual surfaces of the virtual venue.

11. The content mapping server of claim 10, wherein the instructions, when executed by the processor, configure the processor to:
map the virtual content item from two-dimensional pixel coordinates to normalized UV coordinates;
remap the normalized UV coordinates to spherical coordinates using a spherical transform (ST) map; and
convert the spherical coordinates to three-dimensional Cartesian coordinates corresponding to the plurality of three-dimensional virtual surfaces of the virtual venue.

12. The content mapping server of claim 8, wherein the instructions, when executed by the processor, configures the processor to project the one or more virtual renderings onto a two-dimensional representation of the virtual venue having the plurality of three-dimensional virtual surfaces to generate the virtual texture map.

13. The content mapping server of claim 12, wherein the two-dimensional representation comprises an equirectangular projection of the virtual venue.

14. The content mapping server of claim 8, wherein the instructions, when executed by the processor, configure the processor to stitch and blend adjacent virtual renderings from among the plurality of adjacent virtual renderings to generate a visually continuous and seamless representation of the virtual content item.

15. A system for mapping a real-world content item, the system comprising:
a real-world venue having a plurality of three-dimensional physical surfaces; and
a content mapping server configured to:
identify a plurality of three-dimensional virtual surfaces of a virtual venue corresponding to a plurality of three-dimensional physical surfaces of the real-world venue;
access a virtual content item;
transform the virtual content item to generate one or more virtual renderings for the plurality of three-dimensional virtual surfaces;
map the one or more virtual renderings onto the plurality of three-dimensional virtual surfaces to generate a virtual texture map; and
cause the real-world venue to display the virtual texture map as the real-world content item on the plurality of three-dimensional physical surfaces.

16. The system of claim 15, wherein the content mapping server is configured to compute a spatial correspondence between the plurality of virtual renderings and the plurality of three-dimensional virtual surfaces of the virtual venue.

17. The system of claim 16, wherein the content mapping server is configured to:
map the virtual content item from two-dimensional pixel coordinates to normalized UV coordinates;
remap the normalized UV coordinates to spherical coordinates using a spherical transform (ST) map; and
convert the spherical coordinates to three-dimensional Cartesian coordinates corresponding to the plurality of three-dimensional virtual surfaces of the virtual venue.

18. The system of claim 15, wherein the content mapping server is configured to project the one or more virtual renderings onto a two-dimensional representation of the virtual venue having the plurality of three-dimensional virtual surfaces to generate the virtual texture map.

19. The content mapping server of claim 18, wherein the two-dimensional representation comprises an equirectangular projection of the virtual venue.

20. The content mapping server of claim 15, wherein the content mapping server is configured to stitch and blend adjacent virtual renderings from among the plurality of adjacent virtual renderings to generate a visually continuous and seamless representation of the virtual content item.
